(19) United States
(12) Patent Application Publication
(10) Pub. No.: US 2026/0304246 A1
(43) Pub. Date: Oct. 1, 2026

(54) EARLY CARRIER AGGREGATION PREPARATION FOR HANDOVER

(71) Applicant: QUALCOMM Incorporated, San Diego, CA (US)

(72) Inventors: Yan ZHOU, San Diego, CA (US); Kiran VENUGOPAL, Green Brook, NJ (US); Kianoush HOSSEINI, San Diego, CA (US); Jing JIANG, San Diego, CA (US)

(21) Appl. No.: 19/462,830

(22) Filed: Jan. 28, 2026

Related U.S. Application Data
(60) Provisional application No. 63/779,111, filed on Mar. 27, 2025.

(51) Int. Cl. H04W 36/00; H04W 36/08

(52) U.S. Cl. CPC H04W 36/00692; H04W 36/0061; H04W 36/0072; H04W 36/00835; H04W 36/085

(57) ABSTRACT

This disclosure provides methods, components, devices and systems for early carrier aggregation (CA) preparation for handover. For example, a user equipment (UE) may receive configuration information associated with a set of candidate cells, where the set of candidate cells includes at least a primary cell and one or more secondary cells, and where the configuration information is associated with acquisition, by the UE, of one or more target secondary cell parameters before reception of a cell switch command or secondary cell activation command, or at a same time as the reception of the cell switch command or secondary cell activation command. The UE may perform a secondary cell preparation procedure associated with the one or more secondary cells in accordance with the configuration information and may transmit a mobility report that includes an indication of one or metrics associated with the one or more secondary cells.

### CROSS REFERENCE

The present application for patent claims the benefit of U.S. Provisional Patent Application No. 63/779,111 by ZHOU et al., entitled “EARLY CARRIER AGGREGATION PREPARATION FOR HANDOVER,” filed Mar. 27, 2025, assigned to the assignee hereof, and expressly incorporated by reference herein.

### TECHNICAL FIELD

This disclosure relates generally to wireless communication, and more specifically to systems, devices, methods, and techniques associated with early carrier aggregation preparation for handover.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:
A method for wireless communications by a UE is described. The method may include receiving configuration information associated with a set of multiple candidate cells, where the set of multiple candidate cells includes at least a primary cell and one or more secondary cells, and where the configuration information is associated with acquisition, by the UE, of one or more target secondary cell parameters before a reception of a cell switch command or secondary cell activation command, at a same time as the reception of the cell switch command or secondary cell activation command, or both, performing a secondary cell preparation procedure associated with the one or more secondary cells in accordance with the configuration information, and transmitting a mobility report that includes an indication of one or metrics associated with the one or more secondary cells and based on the secondary cell preparation procedure.

A UE for wireless communications is described. The UE may include a processing system that includes processor circuitry and memory circuitry that stores code. The processing system may be configured to cause the UE to receive configuration information associated with a set of multiple candidate cells, where the set of multiple candidate cells includes at least a primary cell and one or more secondary cells, and where the configuration information is associated with acquisition, by the UE, of one or more target secondary cell parameters before a reception of a cell switch command or secondary cell activation command, at a same time as the reception of the cell switch command or secondary cell activation command, or both, perform a secondary cell preparation procedure associated with the one or more secondary cells in accordance with the configuration information, and transmit a mobility report that includes an indication of one or metrics associated with the one or more secondary cells and based on the secondary cell preparation procedure.

Another UE for wireless communications is described. The UE may include means for receiving configuration information associated with a set of multiple candidate cells, where the set of multiple candidate cells includes at least a primary cell and one or more secondary cells, and where the configuration information is associated with acquisition, by the UE, of one or more target secondary cell parameters before a reception of a cell switch command or secondary cell activation command, at a same time as the reception of the cell switch command or secondary cell activation command, or both, means for performing a secondary cell preparation procedure associated with the one or more secondary cells in accordance with the configuration information, and means for transmitting a mobility report that includes an indication of one or metrics associated with the one or more secondary cells and based on the secondary cell preparation procedure.

A non-transitory computer-readable medium storing code for wireless communications is described. The code may include instructions executable by one or more processors to receive configuration information associated with a set of multiple candidate cells, where the set of multiple candidate cells includes at least a primary cell and one or more secondary cells, and where the configuration information is associated with acquisition, by the UE, of one or more target secondary cell parameters before a reception of a cell switch command or secondary cell activation command, at a same time as the reception of the cell switch command or secondary cell activation command, or both, perform a secondary cell preparation procedure associated with the one or more secondary cells in accordance with the configuration information, and transmit a mobility report that includes an indication of one or metrics associated with the one or more secondary cells and based on the secondary cell preparation procedure.

In some examples of the method, UEs, and non-transitory computer-readable medium described herein, receiving the configuration information may include operations, features, means, or instructions for receiving a set of multiple first configurations that pertain to the acquisition of the one or more target secondary cell parameters, where the set of multiple first configurations may be associated with first resources on a per-resource basis, and where the first resources may be bands or locations or combinations thereof that differ from second resources associated with the primary cell.

Some examples of the method, UEs, and non-transitory computer-readable medium described herein may further include operations, features, means, or instructions for transmitting, as part of the secondary cell preparation procedure, one or more sounding reference signals in accordance with the configuration information, where transmission of the one or more sounding reference signals may be for determination of one or more precoders for uplink communications, downlink communications or both, or may be associated with one or more beam refinement procedures.

Some examples of the method, UEs, and non-transitory computer-readable medium described herein may further include operations, features, means, or instructions for obtaining, as part of the secondary cell preparation procedure, one or more channel state information measurements associated with the one or more secondary cells in accordance with the configuration information and generating a channel state information report for the one or more secondary cells based on the one or more channel state information measurements, where generation of the channel state information report may be for determination of one or more precoders for downlink communications, or may be associated with one or more beam refinement procedures.

Some examples of the method, UEs, and non-transitory computer-readable medium described herein may further include operations, features, means, or instructions for receiving signaling associated with an uplink synchronization procedure, where the signaling indicates one or more cells of the set of multiple candidate cells including at least the one or more secondary cells for timing synchronization during the uplink synchronization procedure.

Some examples of the method, UEs, and non-transitory computer-readable medium described herein may further include operations, features, means, or instructions for performing the uplink synchronization procedure for the one or more cells of the set of multiple candidate cells in accordance with the signaling and in accordance with an ordering, where the ordering may be based on index values for each cell of the set of multiple candidate cells, one or more uplink synchronization configuration identifiers indicated by the signaling and associated with each cell of the set of multiple candidate cells, or both.

In some examples of the method, UEs, and non-transitory computer-readable medium described herein, performing the uplink synchronization procedure may include operations, features, means, or instructions for determining a set of multiple timing advances, with each timing advance corresponding to an individual configuration of a set of multiple first configurations, and where the set of multiple first configurations include the configuration information that pertains to the acquisition of the one or more target secondary cell parameters.

Some examples of the method, UEs, and non-transitory computer-readable medium described herein may further include operations, features, means, or instructions for receiving signaling indicating an activation of one or more transmission control indicator states of a set of multiple transmission control indicator states included in the configuration information, where each transmission control indicator state of the set of multiple transmission control indicator states may be associated with a respective secondary cell of the one or more secondary cells.

Some examples of the method, UEs, and non-transitory computer-readable medium described herein may further include operations, features, means, or instructions for receiving signaling indicating a set of multiple reference signal sets, where each reference signal set of the set of multiple reference signal sets may be associated with a respective secondary cell of the one or more secondary cells.

In some examples of the method, UEs, and non-transitory computer-readable medium described herein, each reference signal set of the set of multiple reference signal sets may be associated with a respective reference signal identifier value indicated by the signaling and associated with each cell of the set of multiple candidate cells, indicated by the configuration information, or both.

Some examples of the method, UEs, and non-transitory computer-readable medium described herein may further include operations, features, means, or instructions for obtaining, for the one or more secondary cells, the one or more metrics in accordance with the configuration information.

Some examples of the method, UEs, and non-transitory computer-readable medium described herein may further include operations, features, means, or instructions for transmitting, via the mobility report, an indication of one or more beams per candidate cell of the set of multiple candidate cells and an indication of a respective metric of the one or more metrics for each beam of the one or more beams per candidate cell, where a quantity of candidate cells included in the mobility report satisfies a threshold quantity of candidate cells, and where an order of the one or more beams per candidate cell may be in accordance with the respective metric, a cell type, a candidate cell configuration, or any combination thereof.

Some examples of the method, UEs, and non-transitory computer-readable medium described herein may further include operations, features, means, or instructions for transmitting, via the mobility report, an indication of one or more reserved entries of the mobility report, an indication of one or more additional respective metrics associated with one or more additional cells different from the primary cell and the one or more secondary cells, or both in accordance with the quantity of candidate cells included in the mobility report failing to satisfy the threshold quantity of candidate cells, where a quantity of the one or more reserved entries, a quantity of the one or more additional cells, or both included in the mobility report may be in accordance with the threshold quantity of candidate cells.

Some examples of the method, UEs, and non-transitory computer-readable medium described herein may further include operations, features, means, or instructions for transmitting signaling indicating a report size associated with the mobility report, where the report size may be in accordance with the quantity of candidate cells included in the mobility report.

Some examples of the method, UEs, and non-transitory computer-readable medium described herein may further include operations, features, means, or instructions for receiving signaling including a cell switch command, the cell switch command including an indication of one or more target cells of the set of multiple candidate cells and a set of multiple additional target cell parameters associated with acquisition, by the UE, of the one or more secondary cells.

Some examples of the method, UEs, and non-transitory computer-readable medium described herein may further include operations, features, means, or instructions for performing a cell switch procedure in accordance with the cell switch command and in accordance with the set of multiple additional target cell parameters, the configuration information, or both, where the cell switch procedure includes switching from communicating with a serving cell to communicating with the one or more target cells.

### BRIEF DESCRIPTION OF THE DRAWINGS

FIG. 1 shows an example of a wireless communication system.

FIG. 2 shows an example of a signaling diagram that supports early carrier aggregation (CA) preparation for handover.

FIGS. 3A through 3D show an example of report formats that support early CA preparation for handover.

FIG. 4 shows an example of a message format that supports early CA preparation for handover.

FIG. 5 shows an example of a process flow that supports early CA preparation for handover.

FIG. 6 shows a block diagram of a processing system that supports early CA preparation for handover.

FIG. 7 shows a diagram of a system including a device that supports early CA preparation for handover.

FIGS. 8 through 10 show flowcharts illustrating methods that support early CA preparation for handover.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communication systems, a user equipment (UE) may perform a lower-layer triggered mobility (LTM) procedure where the UE may switch from communicating with a serving cell to communicating with a candidate cell of a candidate configuration (e.g., a candidate cell configuration). The candidate configuration may include one or more primary cells (PCells), one or more secondary cells (SCells), or both. In some cases, a network entity may signal a set of cell configuration parameters to the UE, and the UE may perform one or more early preparation procedures, one or more on-demand cell preparation procedures, or both to prepare to communicate with a cell of the candidate configuration. For example, the UE may determine one or more configuration parameters associated with a PCell of the candidate configuration, the UE may obtain one or more channel state information (CSI) measurements associated with the PCell, or the UE may activate one or more transmission control indicator (TCI) states associated with the PCell, among other examples. Accordingly, the UE may, based on receiving a cell switch command from the network entity, or the like, switch to communicating with the PCell of the candidate configuration in accordance with the parameters obtained via the early preparation procedures before receiving the cell switch command. However, the network entity may indicate the cell configuration parameters (e.g., associated with the early preparation commands) for the PCell, and the cell configuration parameters may be invalid for the one or more SCells of the candidate configuration. Accordingly, the UE may be unable to perform the early preparation procedures for the SCells. Instead, the UE may perform one or more SCell activation procedures after switching to the PCell, which may increase latency associated with the cell switch.

Aspects of the subject matter described in this disclosure relate to early carrier aggregation (CA) preparation for handover (e.g., cell handover). For example, the network entity may signal multiple sets of cell configuration parameters (e.g., via multiple sub-configurations) associated with one or more PCells, one or more SCells, or both for a respective candidate configuration. Accordingly, the UE may perform one or more early preparation procedures, one or more on-demand procedures, or both for both of the PCells and the SCells before receiving a cell switch command based on receiving the multiple sets of cell configuration parameters. The UE may transmit a mobility report indicating one or more metrics (e.g., measurement metrics associated with one or more communication beams of the PCells and the SCells. In some examples, the UE may transmit a mobility report including respective metrics for multiple cells (e.g., PCells, SCells, or both) for multiple candidate configurations. In some implementations, the network entity may output, and the UE may receive, a cell switch command. Accordingly, the UE may switch from communicating with a serving cell to communicating with a PCell, a SCell, or both in accordance with the early preparation procedures.

Particular aspects of the subject matter described in this disclosure can be implemented to realize one or more of the following potential advantages. In some examples, by performing the early preparation procedures for the SCells, the described techniques can be used to reduce a latency associated with a cell switch procedure. For example, by performing SCell activation before receiving the cell switch command or at a same time as receiving the cell switch command, the UE may perform communications with the SCell based on performing the cell switch without subsequently waiting for a separate SCell activation (e.g., including a SCell activation command).

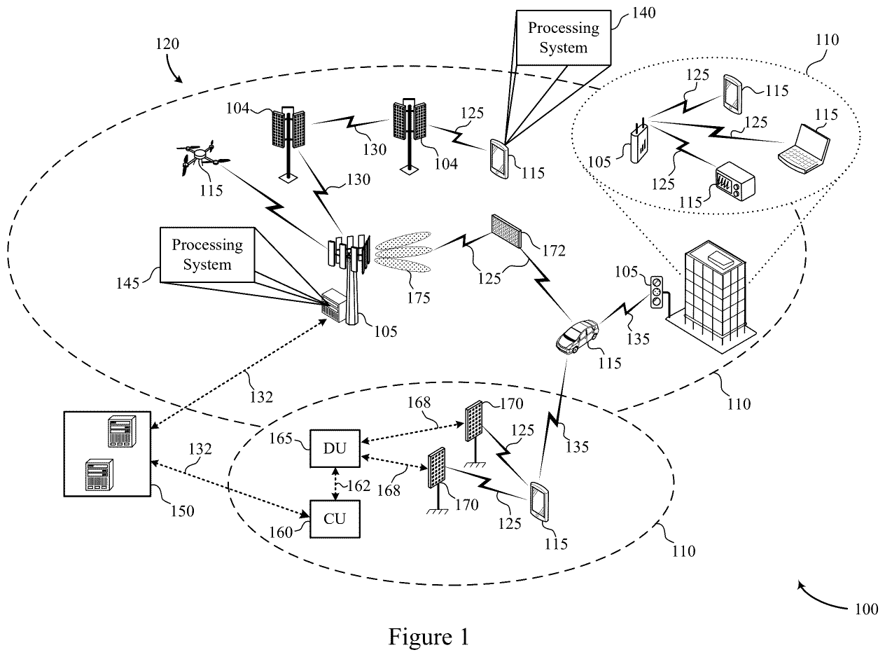

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or both to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHZ), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active uplink BWP, an active downlink BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

Devices of the wireless communication system 100 may be configured to support one or more aspects of the described techniques for early carrier aggregation preparation for handover. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the communication system 100 (such as the RAN 120) may support early CA preparation for handover (e.g., cell handover). For example, the network entity 105 may signal multiple sets of cell configuration parameters (e.g., via multiple sub-configurations) associated with one or more PCells, one or more SCells, or both for a respective candidate configuration. Accordingly, the UE 115 may perform one or more early preparation procedures, one or more on-demand procedures, or both for both of the PCells and the SCells before receiving a cell switch command based on receiving the multiple sets of cell configuration parameters. The UE 115 may transmit a mobility report indicating one or more metrics (e.g., measurement metrics associated with one or more communication beams of the PCells and the SCells. In some examples, the UE 115 may transmit a mobility report including respective metrics for multiple cells (e.g., PCells, SCells, or both) for multiple candidate configurations. In some implementations, the network entity 105 may output, and the UE 115 may receive, a cell switch command. Accordingly, the UE 115 may switch from communicating with a serving cell to communicating with a PCell, a SCell, or both in accordance with the early preparation procedures.

Particular aspects of the subject matter described in this disclosure can be implemented to realize one or more of the following potential advantages. In some examples, by performing the early preparation procedures for the SCells, the described techniques can be used to reduce a latency associated with a cell switch procedure. For example, by performing SCell activation before receiving the cell switch command or at a same time as receiving the cell switch command, the UE 115 may perform communications with the SCell based on performing the cell switch without subsequently waiting for a separate SCell activation (e.g., including a SCell activation command).

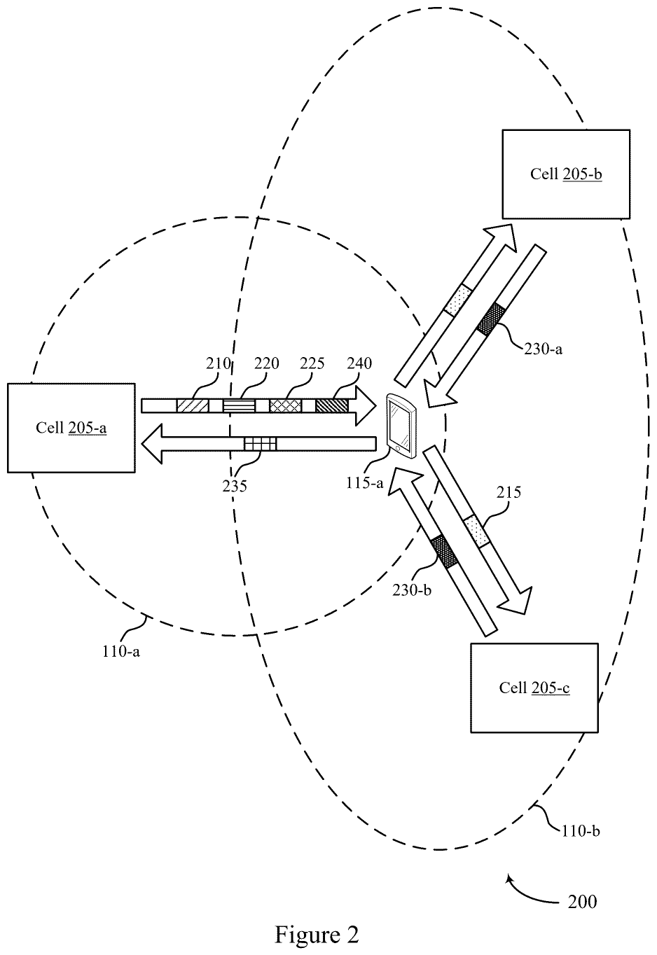

FIG. 2 shows an example of a signaling diagram 200 that supports early CA preparation for handover. Aspects of the signaling diagram 200 may implement or be implemented by aspects of the wireless communication system 100. For example, the signaling diagram 200 may include a UE 115-a, and one or more cells 205 including a cell 205-a, a cell 205-b, and a cell 205-c, which may be examples of the UE 115 and the network entity 105 respectively.

In some cases, various early candidate cell preparation schemes may be utilized to improve throughput after a cell 205-b (e.g., candidate cell) is selected as a target cell (e.g., a cell to switch to communicating with during a cell handover procedure). The cell 205-b generally refers to a candidate PCell. Accordingly, a cell 205-a (e.g., a serving cell for the UE 115-a associated with a coverage area 110-a) may output signaling indicating a CA configuration for the cell 205-b to the UE 115-a in advance (e.g., before a cell switch command or a cell switch procedure). Before handover, for a promising candidate cell (e.g., the cell 205-b), the UE 115-a may determine a reception beam (Rx beam) for a synchronization signal block (SSB) based on one or more Layer-1 (L1) reference signal received power (RSRP) measurements, activate a TCI state associated with the cell 205-b, and determine a corresponding timing advance (TA) value based on one or more random access channel preamble (PRACH) transmissions to the cell 205-b in accordance with the CA configuration for the cell 205-b (e.g., in accordance with one or more of the parameters ltm-SSB-Config-r18, ltm-EarlyUL-SyncConfig-r18, ltm-EarlyUL-SyncConfigSUL-r18, or ltm-TCI-Info-r18). In some cases, before handover (e.g., for a promising candidate cell), the UE 115-a may perform beam refinement with CSI-RS based on the L1-RSRP measurements, may activate the corresponding TCI state, and may determine corresponding CSI parameters for downlink MIMO operations.

In some cases, the cell 205-a may output signaling, to the UE 115-a, indicating one or more CA configurations associated with each candidate PCell of a set of candidate PCells of a candidate cell configuration (e.g., the CA configurations may be provided to the UE 115-a in advance), and the CA configurations may include intra-band continuous or discontinuous CA, or inter-band CA (e.g., no restriction on the CA type), which may be co-located or non-co-located (e.g., for decoupled downlink/uplink). In some cases, the cell 205-a may output an indication of a respective configuration for each band in a CA configuration (e.g., indicating duplex modes, a bandwidth (BW), a quantity of antennas, or a quantity of SSBs for each band), which may be summarized in Table 1 below. In some cases, the UE 115-a may be unable to utilize the early preparation parameters (e.g., PCell early preparation parameters) to prepare for acquisition of one or more SCells (e.g., a cell 205-c), such as when the PCell and the SCells correspond to different bands or locations (e.g., different TCI states, TAs, or CSI). The cell 205-b and the cell 205-c may be associated with a same candidate configuration, a coverage area 110-b, or both.

TABLE 1
Band CA Configurations

| | |
|---|---|
| Band | gNB Configuration |

| | | |
|---|---|---|
| 700 | MHz | FDD, 2 × 20 MHz, 2 antennas, 1 SSB |
| 2 | GHz | TDD, 40 MHz, 4 antennas, 1 SSB |
| 3.5 | GHz | TDD, 100 MHz, 256 antennas, 8 SSB |
| 8 | GHz | TDD, 100 MHz, 1024 antennas, 16 SSB |

In some cases, the UE 115-a may activate (e.g., directly activate) each SCell associated with a selected target PCell (e.g., the cell 205-a) via a corresponding RRC flag in the target CA configuration, or via a separate SCell activation command, (e.g., a command sent from the target PCell after the PCell switch is completed). For example, the UE 115-a may receive the SCell activation command and may activate (e.g., communicate with) a target SCell (e.g., the cell 205-c) according to the command. In such cases, the UE 115-a may be unaware of which SCell to activate prior to receiving the SCell activation command (e.g., since which SCell to activate may not be indicated when candidate cells are configured). Accordingly, the UE 115-a may incur latency when activating the SCell after first performing the cell switch to the PCell (e.g., for a single frequency range 1 (FR1) known SCell, the activation latency may be 22 milliseconds (ms) for SSB based activation and may be reduced to 12 ms for aperiodic tracking reference signal (A-TRS) based activation). In some cases, the UE 115-a may incur additional latency for an increased quantity of activated SCells, unknown SCells, higher FRs, and for downlink or uplink operations, among other examples (e.g., for TA acquisition, beam refinement, corresponding TCI activation, path loss computation, uplink transmitted precoding matrix indicator (TPMI) determination, or for SCells in bands or locations different from target PCell).

For an illustrative example, the UE 115-a may perform a cell switch to a candidate PCell (e.g., the cell 205-b) and may receive a first DCI, followed by a SCell activation command (e.g., via a SCell activation MAC control element (MAC-CE)) and may transmit feedback (e.g., an acknowledgment (ACK) associated with a delay K1 greater than eight symbols)), which may be associated with a time of 2 ms. Correspondingly, the UE 115-a may process the activation command and prepare radio resources associated with the SCell (e.g., RF or baseband (BB)), which may utilize 3 ms (e.g., 6 ms for both operations). Accordingly, the UE 115-a may wait to receive a SSB (e.g., a first SSB as quasi co-located (QCL) source in activated TCI), which may utilize 10 ms (e.g., an average delay of 10 ms), and the UE 115-a may, based on receiving the SSB, perform an SSB process for 2 ms. After performing the SSB process, the UE 115-a may receive a second DCI, may receive one or more CSI-RS associated with the SCell, and may output a CSI report based on the CSI-RS, which may utilize 2 ms. Accordingly, the UE 115-a may perform the SCell activation (e.g., based on receiving an explicit SCell activation command) over a duration of 22 ms, for an example (e.g., an activation latency of 22 ms for an FR1 known SCell).

In some cases, the UE 115-a may perform early uplink synchronization (e.g., uplink sync) for a candidate PCell in each candidate CA configuration (e.g., uplink synchronization for the cell 205-a). However, the UE 115-a may be unable to perform early uplink synchronization for other SCells in the same candidate CA configuration (e.g., the cell 205-b). For example, for PDCCH order-based early uplink synchronization, the UE 115-a may perform early uplink synchronization for a candidate cell based on an indication in a corresponding DCI, which may include an order index of one or more configured candidate cells (e.g., via an ordering of LTM candidate cell identifiers (IDs)) and may indicate a single cell per candidate CA configuration (e.g., the PCell according to the parameters EarlyUL-SyncConfig or ltm-CandidateId). Additionally, or alternatively, for UE-based (e.g., UE initiated) early uplink synchronization, the UE 115-a may perform early uplink synchronization for the candidate cell (e.g., the cell 205-b), which may be configured for UE-based TA measurement according to the indicated order index of the configured LTM candidate IDs (e.g., according to ltm-ServingCellUE-MeasuredTA-ID-r18 or 1 . . . maxNrofLTM-Configs-plus1-r18).

In some cases, the UE 115-a may be unable to perform early TCI state activation for the cell 205-c. For example, the cell 205-a may output an indication of an early TCI activation for the candidate PCell in each candidate CA configuration (e.g., the cell 205-b), and may be unable to indicate early TCI activation for other SCells in the same candidate CA configuration. For example, the cell 205-a may output a MAC-CE message indicating a candidate cell ID (e.g., an ID of the cell 205-b). However, the cell 205-a may output an indication, via MAC-CE, of a single candidate cell ID (e.g., equal to the configured LTM candidate ID minus one), which correspondingly indicates a single cell per candidate CA configuration (e.g., the PCell). As such, the cell 205-a may be unable to indicate the cell 205-c for early TCI activation.

In some cases, the cell 205-a may output an indication of a single set of SSBs (e.g., via the parameters SSB-Index or LTM-CandidateId-r18) for a candidate configuration ID in a resource set linked to the CSI report configuration for L1 measurement. For example, the cell 205-a may output an indication of a single SSB set associated with each physical cell ID (PCI), where each CSI-RS resource may be QCLed to one SSB in the single set of SSBs. Accordingly, the UE 115-a may perform the L1 measurement for a single cell or band per candidate CA configuration (e.g., the PCell or the associated band), and may be unable to perform L1 measurements for the cell 205-b (e.g., the SCell).

The techniques, methods, and devices described herein may support early CA preparation for handover. For example (e.g., at least for network controlled mobility, or network-triggered LTM), the cell 205-a may provide (e.g., in addition to the candidate PCell) various early or on-demand preparation configurations for one or more candidate SCells (e.g., the cell 205-c) in the same candidate CA configuration such as SCells corresponding to bands, locations, or both that are different from the candidate PCell. Accordingly, the UE 115-a may perform one or more early preparation procedures for the SCells. For example, the UE 115-a may perform early SCell preparations before receiving a cell switch command such that the latency for SCell activation (e.g., switching to a SCell to provide improved downlink or uplink throughput compared to the target PCell) may be reduced after the associated candidate CA configuration is selected as the target and the corresponding target PCell switch is completed.

The UE 115-a may perform early preparation procedures (e.g., before receiving the cell switch command or the SCell activation command) including uplink TA acquisition, downlink time and frequency tracking, automatic gain control (AGC) setting, downlink/uplink beam refinement, TCI activation, CSI measurement, or CSI reporting for downlink MIMO parameter determination (e.g., a rank, a PMI, or a channel quality indicator (CQI)), path loss computation for uplink power control, or uplink MIMO parameter determination (e.g., a rank, a PMI, or a CQI), among other examples. Additionally, or alternatively, the UE 115-a may perform one or more on-demand SCell preparation procedures. As such, the UE 115-a may perform the one or more of the early preparation procedures at a same time as the cell switch command or SCell activation command is received. In some examples, the UE 115-a may perform early preparation procedures for a candidate dual connectivity (DC) configuration. In some examples, the UE 115-a may perform the early preparation procedures ahead of acquisition of a primary SCell (PSCell).

The cell 205-a may output individual early preparation sub-configurations associated with each early preparation function for different cells 205 within a same CA configurations via a same candidate CA configuration (e.g., LTM-Candidate in R18). In some examples, the cell 205-a may output signaling (e.g., DCI or MAC-CE signaling) to schedule early preparation, and each cell 205 in the same CA configuration may be identified by two-level IDs (e.g., a candidate CA configuration ID and a sub-configuration ID) included within the signaling. For example, the cell 205-a may output a DCI or a MAC-CE scheduling early uplink synchronization, early TCI activation, L1 cell measurements and reporting, or a cell switch command, among other examples. The cell 205-a may include the two-level IDs based on a presence of early preparation configurations for the cell 205-b (e.g., PCell) within the candidate CA configuration (e.g., the early preparation configurations for SCells may be included under the candidate CA configuration corresponding to a same information element (IE) to such that a new IE outside candidate CA configuration is not used). Additionally, or alternatively, the cell 205-a may include the two-level IDs such that the UE 115-a may determine which reference signals are associated with respective cells 205 of the candidate CA configuration. Accordingly, the UE 115-a may report reference signals from the same candidate CA configuration, and the cell 205-a may correspondingly determine (e.g., assess) a general CA configuration performance per reported candidate CA.

The UE 115-a may transmit a report according to a report format with measurements for multiple candidate CA groups (e.g., instead of reporting one PCell per candidate CA configuration). For example, the UE 115-a may report multiple candidate CA groups in one report, where each reported CA group contains an indication of X cells (e.g., top X cells) in that CA configuration. The cell 205-a may output signaling indicating the report format and requesting (e.g., configuring) one or more cells to be included in the report by the UE 115-a (e.g., a PCell based on the CA group report). Accordingly, based on receiving the report from the UE 115-a, the cell 205-a may determine (e.g., compute) the general CA performance (e.g., a throughput offered per candidate CA configuration). In some examples, the UE 115-a may determine which reference signal is from which cell under which CA configuration (e.g., to generate and transmit the report for each CA configuration) based on the two-level IDs.

In some implementations, the cell 205-a may output configuration information 210 indicating one or more cell candidate configurations, where each candidate configuration may include multiple early preparation sub-configs (e.g., ltm-Candidate-SubConfigToAddModList-r18 or ltm-Candidate-SubConfigId) for one or more candidate SCells (e.g., sub-configs for SCells in bands and/or locations different from the candidate PCell instead of the single set of early preparation configurations for the candidate PCell). For example, the cell 205-a may output the configuration information 210 including an indication of a candidate configuration associated with the cell 205-a and the cell 205-b (e.g., an LTM candidate configuration with multiple early preparation sub-configs for PCell and SCells). In some examples, the candidate configuration may include a first early preparation sub-config may be associated with the candidate PCell (e.g., the cell 205-b in band 1 or location 1), and a second early preparation sub-config that may be associated with the candidate SCell (e.g., the cell 205-c in band 2 or location 2). Additionally, or alternatively, the cell 205-a may output, via the candidate configuration, a third early preparation sub-config associated with one or more additional candidate SCells (e.g., in band 3 or location 3), among other examples.

In some implementations, the cell 205-a may provide, via the sub-configurations indicated by the configuration information 210, one or more configurations for SSBs (e.g., periodic SSBs or on-demand SSBs), early uplink sync including RACH configuration and response, TCI state pools per TCI type (e.g., TCI types including downlink, uplink, or joint TCI), CSI-RS resources per type (e.g., beam management (BM), CSI, TRS), frequency reference points (e.g., point A), MAC reset flags, UE-based TA measurement configurations, path loss reference signals, or the like, where each sub-config may include different sets of early preparation configurations. Additionally, or alternatively, the cell 205-a may transmit an indication, via the sub-configs, of downlink or uplink reference signals in each sub-config including QCL source reference signals such as SSB, CSI-RS, or sounding reference signals (SRS).

In some implementations, the cell 205-a may output an indication, via the configuration information 210, of one or more candidate sub-config parameters (e.g., IEs) associated with one or more operations (e.g., operations of the UE 115-a) such as early SRS transmission and early CSI reporting for the corresponding candidate SCell before receiving the cell switch command. For example, the UE 115-a may transmit one or more SRS 215 (e.g., to the cell 205-b) based on the corresponding sub-config for the cell 205-b. Accordingly, the UE 115-a, the cell 205-b, or both may determine one or more uplink or downlink MIMO precoders, or uplink beam refinement for the cell 205-b cell before cell switch based on the early SRS transmission. In such cases, the UE 115-a may determine, based on a corresponding IE, one or more SRS resources or resource sets for different operations (e.g., antenna switching, codebook or non-codebook-based uplink transmission, or beam management), as well as for corresponding power control parameters (e.g., PO, alpha, closed loop index, or a path loss reference signal).

Additionally, or alternatively, the UE 115-a may perform early CSI reporting (e.g., based on one or more IEs included in the sub-config). For example, the UE 115-a may generate a CSI report, which may be utilized by the UE 115-a, the cell 205-b, or both to determine a downlink MIMO precoder or beam refinement for the cell 205-b before cell switch.

In some implementations, the cell 205-a may output an indication for the UE 115-a to perform early uplink synchronization for the candidate SCells each candidate CA configuration and whether the UE 115-a may perform uplink synchronization on normal uplink (NUL) or supplementary uplink (SUL) bands of each indicated candidate SCell. For example, the cell 205-a may indicate, via the configuration information 210, for the UE 115-a to perform early uplink synchronization for the cell 205-c.

In some implementations, the cell 205-a may output a DCI message 220 (e.g., a PDCCH order) indicating the early uplink synchronization, and the DCI message 220 may include a cell indicator field indicating both of the cell 205-b and the cell 205-c (e.g., both PCell and SCell(s) per candidate configuration). For example, the cell 205-a may indicate, via the DCI message 220, a cell index where one or more cells are grouped according to one or more respective CA configurations. For example, the cell 205-a may indicate, via the DCI message 220, an order index of the Cell1, Cell 2, through Cell N1 with early uplink synchronization configurations in a first CA configuration, and followed by the Cell 1, Cell 2, through Cell N2 with early uplink synchronization configurations in a second CA configuration, and so on (e.g., where the first CA configuration may be a current serving CA configuration associated with the cell 205-a, the second CA configuration may be the first candidate CA configuration associated with the cell 205-b and the cell 205-c, the third CA configuration may be a second candidate CA configuration, and so on, based on a candidate configuration ID order).

For an illustrative example, the cell 205-a may indicate, via the DCI message 220, an ordering including the Cell 1, the Cell 2, through a Cell X in a CA configuration based on the order of corresponding early uplink synchronization configuration IDs in the CA configuration, which may be represented by IDs of other IEs containing the early uplink synchronization configuration (e.g., the early preparation sub-configurations indicated by the configuration information 210). In some examples, the Cell1 in a CA configuration may indicate the corresponding PCell of the CA configuration. Additionally, or alternatively, the UE 115-a may identify the early uplink synchronization configuration via an ID (e.g., a global ID) across all serving and candidate CA configurations, and the indicated cell index may be based on the order index of this global early uplink synchronization configuration ID.

In some implementations, the UE 115-a may perform UE-based (e.g., UE initiated) uplink synchronization. In such implementations, the cell 205-a may output signaling including a cell indicator indicating both the cell 205-b and the cell 205-c (e.g., both PCell and SCell(s) per candidate configuration). Additionally, or alternatively, the cell 205-a may output the cell indicator signaling via RRC signaling, MAC-CE signaling, or a DCI (e.g., the DCI message 220).

In some examples, the cell 205-a may output an indication, to the UE 115-a, to measure multiple TAs based on one or more different early uplink synchronization sub-configs in a selected candidate configuration (e.g., instead of a single TA). In such examples, the UE 115-a may measure the multiple TAs according to the selected multiple early uplink sync sub-configs within the selected candidate config, which may be identified, by the UE 115-a, according to one or more respective IDs (e.g., ltm-ServingCellUE-MeasuredTA-SubID) or by IDs of other IEs containing the early uplink sync config (e.g., the early preparation sub-configs of the configuration information 210, or the LIM-Candidate-SubConfigId). Additionally, or alternatively, the UE 115-a may identity the early uplink synchronization configuration via an ID (e.g., a global ID) across all serving and candidate CA configurations, and the indicated cell index may be based on the order index of this global early uplink synchronization configuration ID.

In some implementations, the cell 205-a may output a MAC-CE message 225 (e.g., or a DCI message) indicating, via a candidate cell ID field of the MAC-CE message 225 (e.g., an extended candidate cell ID field) early TCI activation for the cell 205-b and the cell 205-c (e.g., PCell and/or SCell(s) per candidate configuration). For example, the cell 205-a may indicate, via the MAC-CE message 225, multiple TCI pools for a same TCI type associated with each candidate configuration (e.g., a downlink, uplink, or joint downlink/uplink TCI), where the TCI pool may be utilized by a candidate cell in the respective candidate CA configurations. In such examples, the cell 205-a may indicate, via the MAC-CE message 225 (e.g., a TCI activation MAC-CE or via a DCI message), which TCI pool ID of the multiple TCI pools may be utilized by a respective cell such as the cell 205-c (e.g., which TCI state of the multiple TCI pools are activated by the cell 205-c). For example, as shown by Table 2 below, cell 205-a may indicate, via one or more reserved bits (R) (e.g., reserved bits 7 and 6 of October 1 of the MAC-CE message 225) of the MAC-CE message 225, a TCI pool ID corresponding to the active TCI states. Additionally, or alternatively, the cell 205-a may indicate the TCI pool ID via IDs of other IEs containing the TCI pool configuration via the configuration information 210 (e.g., the early preparation sub-configs).

TABLE 2
TCI Activation MAC-CE

| 7 | 6 | 5 | 4 | 3 | 2 | 1 | 0 | |
|---|---|---|---|---|---|---|---|---|
| R | R | R | R | R | Candidate Cell ID | | | Oct 1 |
| R | R | R | R | R | R | R | R | Oct 2 |

| | | |
|---|---|---|
| D/U | TCI state ID 1 | Oct 3 |
| D/U | TCI state ID 2 | Oct 4 |

. . .

| | | |
|---|---|---|
| D/U | TCI state ID N | Oct N + 2 |

For example, the cell 205-a may indicate, via the reserved bits of the MAC-CE message 225, the activated TCI state for a single cell such as the cell 205-c. In such examples, for the candidate configuration including both of the cell 205-b and the cell 205-c, the cell 205-a may output multiple MAC-CE messages for multiple candidate cells. For an illustrative example, the cell 205-a may output a first MAC-CE message (not shown) and a second MAC-CE message (not shown) according to the format of the MAC-CE message 225, where the first MAC-CE message indicates an activated TCI state for the cell 205-b and the second MACE-CE message indicates an activated TCI state for the cell 205-c.

In some implementations, the cell 205-a may indicate, via the MAC-CE message 225 (e.g., or a DCI message), one or more activated TCI states associated with multiple TCI pools of a candidate CA configuration (e.g., associated with multiple cells of the candidate CA configuration). For example, the cell 205-a may indicate, via the MAC-CE message 225 (e.g., or a DCI message) one or more candidate configuration IDs and activated TCI states associated with one or more TCI pool IDs for each indicated candidate configuration ID. For example, as shown in Table 3 below, the cell 205-a may indicate, via the MAC-CE message 225, a candidate config ID via the candidate cell ID field of the MAC-CE message 225 (e.g., the activation MAC-CE), and the reserved bits (e.g., five reserved bits such as bits 3 through 7 of October 1) may indicate which TCI pools of the respective candidate configuration include activated TCI states (e.g., activated TCI IDs can be concatenated for different TCI pools and the TCI ID fields may be reused to indicate multiple TCI pools).

TABLE 3
TCI Activation MAC-CE

| 7 | 6 | 5 | 4 | 3 | 2 | 1 | 0 | |
|---|---|---|---|---|---|---|---|---|
| R | R | R | R | R | Candidate Cell ID | | | Oct 1 |
| R | R | R | R | R | R | R | R | Oct 2 |

| | | |
|---|---|---|
| D/U | TCI state ID 1 | Oct 3 |
| D/U | TCI state ID 2 | Oct 4 |

. . .

| | | |
|---|---|---|
| D/U | TCI state ID N | Oct N + 2 |

For example, the cell 205-a may indicate a candidate CA configuration via the candidate cell ID field of the MAC-CE message 225, as well as one or more TCI pool IDs associated with each cell of the indicated candidate CA configuration. In such examples, each one of the reserved bits (e.g., the bits 3 through 7) of the MAC-CE message 225 may indicate whether a respective TCI state is activated (e.g., is present, or exists) for a respective cell (e.g., indicated by a respective TCI pool ID field). Each bit of the reserved bits may correspond to a TCI state type. For example, a first reserved bit may correspond to a downlink TCI state, a second reserved bit may correspond to an uplink TCI state, and a third reserved bit may correspond to a joint downlink and uplink TCI state.

For an illustrative example, the cell 205-a may output the MAC-CE message 225, and the MAC-CE message 225 may indicate, via the candidate cell ID field, a candidate CA configuration including the cell 205-b and the cell 205-c. Accordingly, a first TCI state ID value corresponding to a TCI state ID 1 may correspond to the cell 205-b, and the reserved bits may indicate whether one or more different TCI states (e.g., corresponding to different TCI types) are activated for the cell 205-b, and a second TCI state ID value corresponding to a TCI state ID 2 may correspond to the cell 205-c, and the reserved bits may indicate whether the one or more different TCI states (e.g., corresponding to the different TCI types) are activated for the cell 205-c.

In some examples, the UE 115-a may perform early TCI activation for the cell 205-b, the cell 205-c, or both (e.g., both PCells and SCells of respective candidate configurations) based on receiving the MAC-CE message 225.

In some implementations, the UE 115-a may perform L1 measurements for at least the cell 205-c (e.g., for both the PCell and SCell). In such implementations, the cell 205-a may output, via the configuration information 210 or the like, an indication of multiple sets of reference signals for a same candidate configuration. Accordingly, each reference signal set may include a SSB set with a unique PCI, a CSI-RS set with each CSI-RS resource QCLed to an SSB with the same PCI, or both, and each reference signal set may be associated with a respective cell of the candidate configuration (e.g., different reference signal sets correspond to different candidate cells for L1 measurement in the same candidate CA configuration).

In some implementations, the cell 205-a may output, via the configuration information 210 or the like, an indication of an association between one or more measured resource IDs and each candidate sub-configuration ID (e.g., respectively associated with each early preparation sub-configuration). In such implementations, the UE 115-a may identify which measured resource is associated with (e.g., configured under) each sub-configuration (e.g., each measured SSB ID or CSI-RS resource ID is associated with which PCI in the same candidate configuration).

Additionally, or alternatively, the cell 205-a may output, via the configuration information 210 or the like, an indication one or more reference signal IDs (e.g., unique reference signal IDs via a resource configuration for the candidate CA configuration) associated with each SSB set, each CSI-RS set, or both that are associated with (e.g., QCLed to) different PCIs. For example, the UE 115-a may perform one or more reference signal measurements associated with the candidate CA configuration including L1-RSRP measurements, L1 signal to noise plus interference ratio (SINR) measurements, or measurement of CSI parameters such as CQI, rank, PMI, or a layer indicator. Accordingly, the UE 115-a may identify, via the reference signal IDs, which measured reference signals correspond to one or more respective cells of the candidate CA configuration (e.g., based on the reference signal IDs included in a resource configuration for the candidate CA configuration).

For an illustrative example, the UE 115-a may receive one or more reference signals 230 from both of the cell 205-b and the cell 205-c. For example, the UE 115-a may receive a reference signal 230-a from the cell 205-b and a reference signal 230-b from the cell 205-c. In such examples, the UE 115-a may measure and decode each of the reference signal 230-a and the reference signal 230-b and may determine (e.g., decode) a respective reference signal ID for each of the reference signal 230-a and the reference signal 230-b. Accordingly, the UE may determine, based on the respective reference signal IDs and on receiving the indication of the resource configuration via the configuration information 210, an association between the reference signal 230-a and the cell 205-b and between the reference signal 230-b and the cell 205-c (e.g., between the respective reference signal IDs and respective PCIs of the cell 205-b and the cell 205-c).

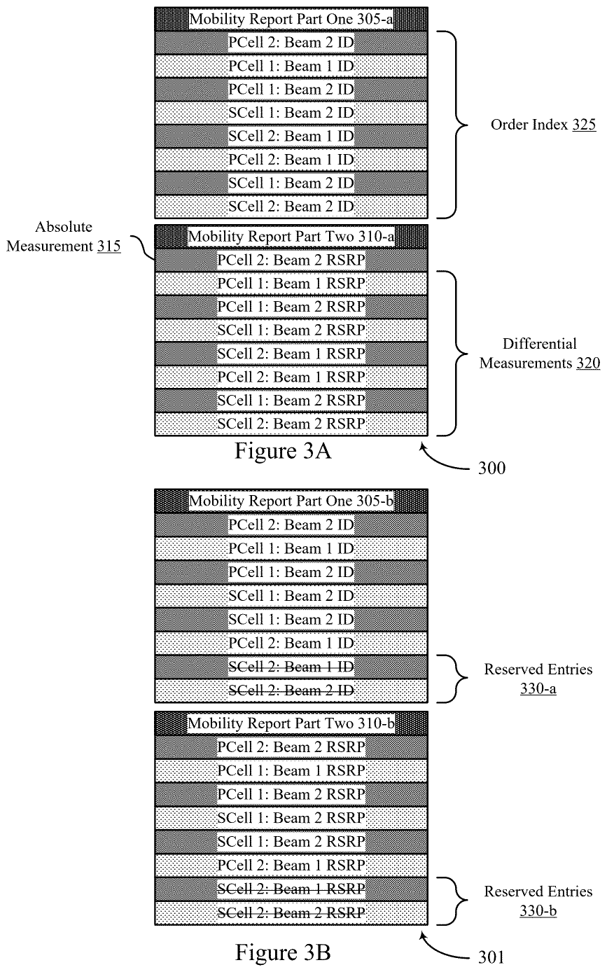

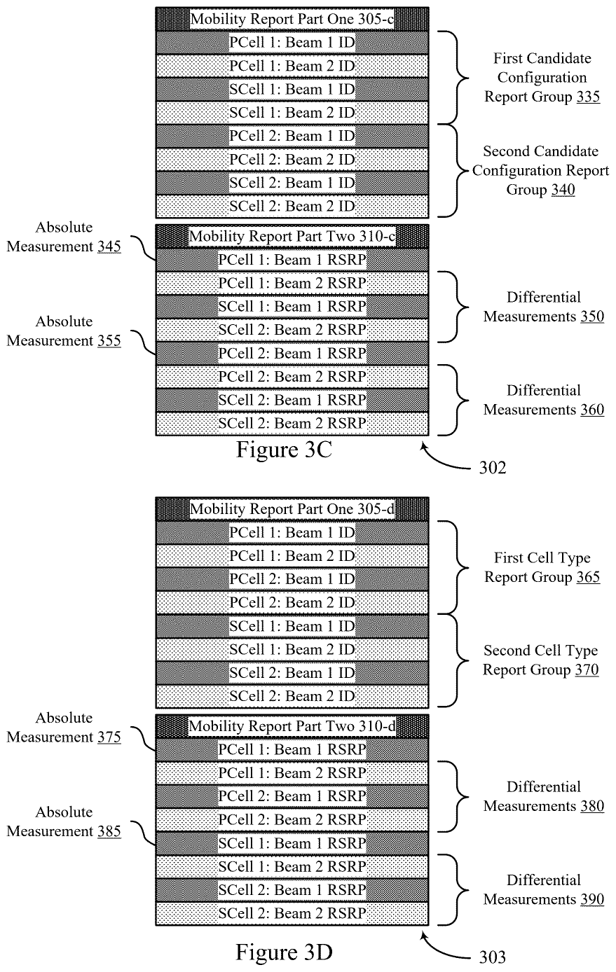

In some implementations, the UE 115-a may generate and transmit a mobility report 235, which is further described herein with reference to FIGS. 3A through 3D. For example, the UE 115-a may generate and transmit the mobility report 235 based on receiving the configuration information 210, or performing the reference signal measurements (e.g., the L1 measurements), or the like. In such examples, the UE 115-a may include, within the mobility report 235, an indication of a respective measurement (e.g., a RSRP measurement) for each beam of each respective cell for one or more candidate CA configurations. For example, the UE 115-a may include, within the mobility report 235, an indication of a measurement for a first beam and a second beam of the cell 205-b and a first beam and a second beam of the cell 205-c.

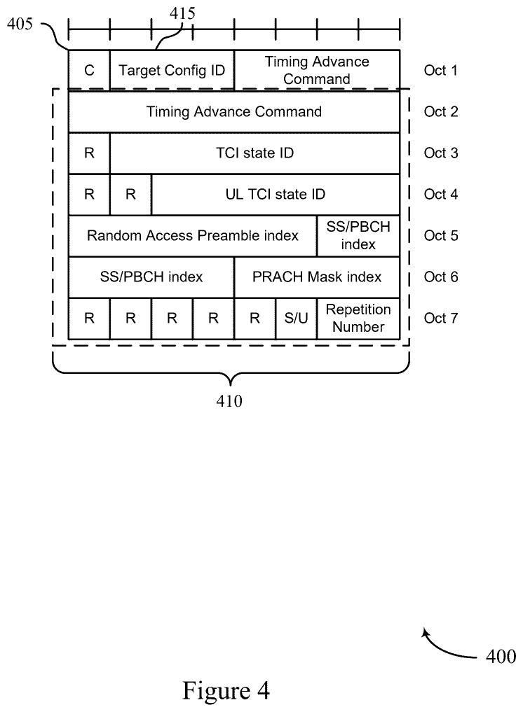

In some implementations, the cell 205-a may output, and the UE 115-a may receive, a cell switch command 240, which may be further described herein with reference to FIG. 4. For example, the cell 205-a may output the cell switch command 240 based on receiving the mobility report 235, or based on one or more other conditions. In such examples, the cell 205-a may indicate, via the cell switch command 240, for the UE 115-a to switch to communicating with the cell 205-b or the cell 205-c. In some examples, the UE 115-a may switch to communicating with the cell 205-c in accordance with the early preparation procedures (e.g., early uplink synchronization, early TCI activation, early SRS transmission, or early CSI report generation).

By performing the early preparation procedures (e.g., early activation procedures) in accordance with at least the configuration information 210, the UE 115-a may activate the cell 205-c (e.g., one or more SCells) and may switch to communicating with the cell 205-c at a same time as receiving the cell switch command 240, which may reduce a latency associated with the cell switch compared to performing SCell activation (e.g., via the SCell activation command) after switching to communicating with the cell 205-b (e.g., the PCell).

FIG. 3A through 3D show examples of a report format 300, a report format 301, a report format 302, and a report format 303 respectively that support early CA preparation for handover. Aspects of the report format 300, a report format 301, a report format 302, and a report format 303 may implement or be implemented by aspects of the wireless communication system 100, the signaling diagram 200, or both. For example, the report format 300, the report format 301, the report format 302, and the report format 303 may be implemented between a UE, which may be an example of the UE 115, and a serving cell (e.g., a serving cell of the UE) which may be an example of the network entity 105 or the one or more cells 205.

In some cases, for LTM L1-RSRP reporting, the serving cell (e.g., a serving cell of the UE) may output information indicating a report configuration that includes M reported reference signals (e.g., nrOfReportedRS-PerCell-r18) for each cell of L candidate cells (e.g., nrOfReportedCells-r18) included in a candidate CA configuration such that a total quantity of reference signal measurements included in the report is L×M. In such cases, the UE may output a mobility report (e.g., a CSI report) including L×M reference signal IDs (e.g., SSB resource indicators (SSBRIs)) and L×M corresponding RSRP values (e.g., in descending order from highest RSRP to lowest RSRP of the reported values), where each reference signal ID corresponds to a respective RSRP value. The parameters associated with the mobility report are summarized in Table 4 below.

TABLE 4
Mobility Report Configuration

| CSI report number | CSI fields |
|---|---|
| CSI report #n | SSBRI #1, if reported |
| | SSBRI #2, if reported |
| | . . . |
| | SSBRI # L × M, if reported |
| | RSRP #1, if reported |
| | Differential RSRP #2, if reported |
| | . . . |
| | Differential RSRP # L × M, if |
| | reported |

NOTE:
L is the number of reported cells provided by higher layer parameter nrOfReportedCells and M is the number of reported SSBRI/RSRP pairs per cell and equal to the value provided by higher layer parameter nrofReportedRS-PerCell.

In some cases, the UE may report (e.g., measure and report) reference signals for a single cell per candidate CA configuration. In cases where both a PCell and a SCell are measured (e.g., as further described herein with reference to FIG. 2), the serving cell may request the measurements for both cells to be reported together per reported candidate configuration (e.g., such that the serving cell may assess an overall CA performance). However, in some cases, the UE may not report the measurements for both cells together based on the UE reporting the measurement values according to respective RSRP values.

The techniques, methods, and devices described herein may support early CA preparation for handover by enabling the UE to report, via the mobility report, reference signals measurements for both of the PCell and the SCell of the candite CA configuration (e.g., report reference signals for the PCell and the SCell together simultaneously). For example, the serving cell may indicate a mobility report configuration to the UE, and the UE may report metrics for multiple cells per candidate configuration (e.g., PCell and X SCells instead of a single reported cell per candidate configuration).

FIG. 3A illustrates an example of the report format 300. In some implementations, the UE may output a mobility report including a mobility report part one 305-a and a mobility report part two 310-a. In such implementations, the UE may report cell IDs or beam IDs according to an order based on respective L1 metric values associated with the reported cells or beams. The UE may report a quantity of cells or beam per cell type (e.g., PCell/SCell) such that a quantity of reported candidate configurations satisfies a quantity of measurements configured by the serving cell.

In some examples, the serving cell may output signaling requesting the UE to report L1 metric values for a quantity of candidate cells, where the quantity of candidate cells includes a threshold first quantity of PCells and a threshold second quantity of SCells (e.g., a requested number of reported cells per cell type including PCells and SCells). In some examples, the UE may output the mobility report including one or more L1 measurements for PCells corresponding to the threshold first quantity of PCell measurements and one or more L1 measurements for SCells corresponding to the threshold second quantity of SCell measurements such that the threshold first quantity of PCell measurements and the threshold second quantity of SCell measurements is satisfied.

In some examples, the UE may order (e.g., rank) the L1 measurements included in the mobility report according to a descending order (e.g., from a highest measured value to a lowest measured value), differential reporting, or both. For example, the UE may select a first L1 measured value (e.g., a highest measured value) as an absolute measurement 315 (e.g., PCell 2: Beam 2 RSRP). Accordingly, the UE may include the absolute measurement 315 in the mobility report part two 310-a and may include one or more different measured values as differential measurements 320 (e.g., in descending order). For example, the UE may represent, within the mobility report part two 310-a, each of the differential measurements 320 as a percentage value, or a fractional value, among other examples, compared to the absolute measurement 315. Accordingly, the UE may include, within the mobility report part one 305-a, the one or more beam IDs corresponding to the L1 measurements, and an order index 325 (e.g., a ranking) of the beam IDs may correspond to the ordering of the L1 measurements included in the mobility report part two 310-a.

For an illustrative example, the UE may generate and transmit a mobility report (e.g., a L1 report) for two candidate CA configurations, where a first reported candidate configuration includes a PCell 1 and a SCell 1, and a second reported candidate configuration includes a PCell 2 and a SCell 2, and where each reported cell includes two reported beams. In such examples, the UE may report eight beams (e.g., 2×2×2=8 beams) according to respective RSRP values of the beams. Accordingly, the UE may include the beam measurements in the mobility report part two 310-a as differential reporting. The UE may report eight beam IDs (e.g., associated with the beam measurements) in the mobility report part one 305-a according to a same ordering (e.g., sorting) as the beam measurements of the mobility report part two 310-a, where each beam ID (e.g., cell ID) may be represented by a corresponding order index in an associated resource set (e.g., the candidate CA configuration).

FIG. 3B illustrates an example of the report format 301. In some implementations, the UE may output a mobility report including a mobility report part one 305-b and a mobility report part two 310-b. In such implementations, the UE may report cell IDs or beam IDs according to an order based on respective L1 metric values associated with the reported cells or beams. The UE may report a quantity of cells or beam per cell type (e.g., PCell/SCell) such that a quantity of reported candidate configurations satisfies a quantity of measurements configured by the serving cell.

In some implementations, the UE may report, via a mobility report, a quantity of beams that fails to satisfy (e.g., is less than) the quantity of reported beams indicated (e.g., requested) by the serving cell. For example, the UE may report one or more beam metrics for a PCell and may refrain from reporting one or more beam metrics for a SCell (e.g., based on a candidate configuration including a PCell such as the PCell 2 and not an additional SCell). Accordingly, the UE may format the mobility report according to one or more formats different from the format described herein with reference to FIG. 3A.

In some implementations, the UE may include, within the mobility report part one 305-b, the mobility report part two 310-b, or both, one or more reserved entries 330 (e.g., a reserved value or a reserved bit pattern). For example, the serving cell may request for the UE to include, within the mobility report, eight beam measurements and the UE may perform six beam measurements (e.g., L1 measurements) based on the indicated candidate CA configurations including six beams (e.g., associated with three cells). Accordingly, the UE may include the six beam measurements within the part two 310-b (e.g., according to one or more orderings described herein with reference to FIG. 3A) and two reserved entries 330-b (e.g., the quantity of reserved entries being based on a total reported beam quantity minus the actual reported beam quantity, or 8−6=2) such that a total quantity of entries in the mobility report satisfies the indicated quantity of reported beams. The UE may include one or more beam IDs according to an ordering of the mobility report part two 310-b and two reserved entries 330-a corresponding to the two reserved entries 330-b.

Additionally, or alternatively, the UE may report, via the mobility report, one or more additional beam measurements associated with an additional candidate CA configuration (e.g., a third candidate CA configuration). For example, the UE may report one or more beams for the additional candidate CA configuration based on a reported quantity of beams associated with the indicated candidate CA configurations (e.g., the first candidate CA configuration and the second candidate CA configuration) failing to satisfy the indicated (e.g., requested) quantity of reported beams, and the UE may include the one or more additional beam measurements for the within the mobility report such that a total quantity of reported beams satisfies the indicated quantity of reported beams. For example, the UE may include the one or more additional beam measurements instead of the one or more reserved entries 330 (e.g., the UE may replace the one or more reserved entries 330 with the additional measurements).

In some implementations, the UE may transmit an indication of a quantity of beam measurements included within the mobility report (e.g., an actual quantity of reported beams or reported entries). For example, the UE may include the indication within a field (e.g., a dedicated field) of the mobility repot based on the mobility report corresponding to MAC-CE signaling (e.g., a MAC-CE format). Additionally, or alternatively, the UE may transmit the indication via a first portion of an uplink control information (UCI) message (e.g., a UCI with constant size) based on the report corresponding to a second portion of the UCI message (e.g., UCI with variable size).

FIG. 3C illustrates an example of the report format 302. In some implementations, the UE may output a mobility report including a mobility report part one 305-c and a mobility report part two 310-c. In such implementations, the UE may report cell IDs or beam IDs according to an order based on respective L1 metric values associated with the reported cells or beams. The UE may report a quantity of cells or beam per cell type (e.g., PCell/SCell) such that a quantity of reported candidate configurations satisfies a quantity of measurements configured by the serving cell.

In some implementations, the UE may report the beam measurements according to one or more groupings. For example, the UE may group the beam measurements according to a respective candidate configuration (e.g., cell IDs or beam IDs grouped per reported candidate configuration). Accordingly, the UE may include each beam measurement associated with a first candidate cell in a respective first portion of the mobility report and may include each beam measurement associated with a second candidate cell in a respective second portion of the mobility report. In such examples, the UE may order the beam measurements differentially for each respective group as further described herein with reference to FIG. 3A.

For an illustrative example, the UE may select two candidate configurations to report including the first candidate configuration and the second candidate configuration (e.g., in accordance with a report configuration output by the serving cell), and each candidate configuration of the selected two candidate configurations may include a PCell and a SCell (e.g., PCell 1, SCell 1, and PCell 2 and SCell2 respectively). The UE may perform one or more beam measurements for each cell of the selected two candidate configurations and may generate the mobility report based on the measurements. For example, the UE may include a first candidate configuration report group 335 and a second candidate configuration report group 340 within the mobility report part one 305-c, and an ordering of each of the first candidate configuration report group 335 and the second candidate configuration report group 340 may be based on an ordering of the mobility report part two 310-c according to one or more techniques further described herein with reference to FIG. 3A. For example, the UE may select a first beam measurement (e.g., PCell 1: Beam 1 RSRP) of the first candidate configuration report group 335 as an absolute measurement 345, and the UE may order each different beam measurement of the first candidate configuration report group 335 as differential measurements 350 compared to (e.g., with respect to) the absolute measurement 345. The UE may select a second beam measurement (e.g., PCell 2: Beam 1 RSRP) of the second candidate configuration report group 340 as an absolute measurement 355 and the UE may order each different beam measurement of the second candidate configuration report group 340 as differential measurements 360 compared to (e.g., with respect to) the absolute measurement 355. Accordingly, the UE may include each reported beam ID according to an associated order index in the resource set (e.g., the candidate CA configuration indicated by the serving cell).

In some examples, if a quantity of beam measurements corresponding to the first candidate configuration report group 335 and the second candidate configuration report group 340 fails to satisfy the quantity of beams requested by the serving cell, the UE may generate (e.g., format) the mobility report according to one or more techniques further described herein with reference to FIG. 3B.

FIG. 3D illustrates an example of the report format 303. In some implementations, the UE may output a mobility report including a mobility report part one 305-d and a mobility report part two 310-d. In such implementations, the UE may report cell IDs or beam IDs according to an order based on respective L1 metric values associated with the reported cells or beams. The UE may report a quantity of cells or beam per cell type (e.g., PCell/SCell) such that a quantity of reported candidate configurations satisfies a quantity of measurements configured by the serving cell.

In some implementations, the UE may report the beam measurements according to one or more groupings. For example, the UE may group the beam measurements according to a respective cell type (e.g., PCells or SCells) of one or more cells included within one or more candidate configurations. Accordingly, the UE may include each beam measurement associated with a first cell type (e.g., PCell) in a respective first portion of the mobility report and may include each beam measurement associated with a second cell type (e.g., SCell) in a respective second portion of the mobility report. In such examples, the UE may order the beam measurements differentially for each respective group as further described herein with reference to FIG. 3A.

For an illustrative example, the UE may select two candidate configurations to report including the first candidate configuration and the second candidate configuration (e.g., in accordance with a report configuration output by the serving cell), and each candidate configuration of the selected two candidate configurations may include a PCell and a SCell (e.g., PCell 1, SCell 1, and PCell 2 and SCell2 respectively). The UE may perform one or more beam measurements for each of cell of the selected two candidate configurations and may generate the mobility report based on the measurements. For example, the UE may include a first cell type report group 365 and a second cell type report group 370 within the mobility report part one 305-d, and an ordering of each of the first cell type report group 365 and the second cell type report group 370 may be based on an ordering of the mobility report part two 310-d according to one or more techniques further described herein with reference to FIG. 3A. For example, the UE may select a first beam measurement (e.g., PCell 1: Beam 1 RSRP) of the first cell type report group 365 as an absolute measurement 375 and the UE may order each different beam measurement of the first cell type report group 365 as differential measurements 380 compared to (e.g., with respect to) the absolute measurement 375. The UE may select a second beam measurement (e.g., SCell 1: Beam 1 RSRP) of the second cell type report group 370 as an absolute measurement 385 and the UE may order each different beam measurement of the second cell type report group 370 as differential measurements 390 compared to (e.g., with respect to) the absolute measurement 355. Accordingly, the UE may include each reported beam ID according to an associated order index in the resource set (e.g., the candidate CA configuration indicated by the serving cell).

In some examples, if a quantity of beam measurements corresponding to the first cell type report group 365 and the second cell type report group 370 fails to satisfy the quantity of beams requested by the serving cell, the UE may generate (e.g., format) the mobility report according to one or more techniques further described herein with reference to FIG. 3B.

By generating and transmitting the mobility report according to one or more techniques described herein, the UE may include beam measurement reports for both PCells and SCells associated with multiple candidate CA configurations, and, as such, the serving cell may determine (e.g., assess) the overall performance of each candidate CA configuration (e.g., including a performance of the SCells). Accordingly, the serving cell may indicate a cell switch to the UE based on determining a relatively well-performing candidate CA configuration of the multiple candidate CA configurations.

FIG. 4 shows an example of a message format 400 that supports early CA preparation for handover. Aspects of the message format 400 may implement or be implemented by aspects of the wireless communication system 100, the signaling diagram 200, or both. For example, the message format 400 may be implemented between a UE, which may be an example of the UE 115, and a cell (e.g., a serving cell of the UE) which may be an example of the network entity 105 or the one or more cells 205.

In some cases, the serving cell may output, and the UE may receive, a cell switch command 405 (e.g., a LTM cell switch command) including, via one or more fields 410, an indication of a single set of parameters associated with acquisition of a target PCell of a selected target configuration (e.g., a selected target configuration ID), which may include a TA, or a TCI state ID per TCI type (e.g., joint TCI, downlink TCI, or uplink TCI), among other examples. In some cases, for a RACH-based cell switch, the serving cell may signal additional parameters associated with the target PCell, including a PRACH preamble ID, a SSB ID, a PRACH mask ID, an uplink carrier (e.g., SUL or NUL), a PRACH repetition quantity, or the like. However, the serving cell may refrain from including, within the cell switch command, parameters associated with one or more target SCells.

The techniques, methods, and devices described herein may support early CA preparation for handover. For example, in some implementations, the serving cell may signal a set of parameters for one or more target SCells of the candidate configuration.

In some implementations, the serving cell may output configuration information including an indication of one or more sub-configurations (e.g., sub-configuration IDs) associated with respective cells of a candidate CA configuration (e.g., PCells and SCells), which is further described herein with reference to FIG. 2. In such implementations, the serving cell may output multiple sets of parameters (e.g., including TCI pools, SSB configurations, or early uplink synchronization configurations for NUL and SUL) for acquisition of the respective cells via the sub-configurations. In some examples, the sub-configurations (e.g., sub-configuration IDs) may be associated with a logic SCell ID in the target configuration (e.g., target candidate CA configuration), which may be configured, by the serving cell, or the like, under the sub-configuration or dynamically indicated in the cell switch command. For example, the serving cell may output the configuration information including the sub-configurations, where each sub-configuration may include a set of parameters for acquisition of a respective cell (e.g., a SCell) and which may be associated with the cell via an association with a respective logic SCell ID in the candidate CA configuration. Additionally, or alternatively, the serving cell may output the cell switch command 405, and a field of the cell switch command 405 (e.g., a target configuration ID field 415) may indicate which sub-configuration ID indicated in the candidate CA configuration and including the set of parameters for cell acquisition is associated with a respective target cell indicated by the cell switch command 405 (e.g., indicated for cell switch by the cell switch command 405).

In some implementations, the serving cell may output signaling indicating the candidate CA configuration, which may include an indication of the one or more SCells via respective logic SCell IDs (e.g., in the target configuration). The UE may receive (e.g., parse and decode) the candidate CA configuration and may identify, via the logic SCell IDs, one or more candidate cells (e.g., target PCells and SCells). In some examples, the serving cell may output signaling indicating the cell switch command 405, which may include, via the one or more fields 410, one or more additional parameters for acquisition of one or more of the candidate cells associated with each target PCell and SCell indicated by the cell switch command 405. In some examples, the additional parameters may include a PMI, a rank, a modulation and coding scheme (MCS) for downlink MIMO (e.g., for semi-persistent scheduling (SPS)), or a TPMI, a rank, a MCS for uplink MIMO (e.g., for configured grants (CG)), or any combination thereof.

By indicating the set of parameters for cell acquisition for one or more SCells in the candidate CA configuration, in the cell switch command 405, or both, the serving cell may support performing, at the UE, SCell activation before receiving the cell switch command 405 or at a same time as receiving the cell switch command 405. which may may reduce a latency associated with SCell activation (e.g., latency based on performing SCell activation after performing a cell switch to the PCell).

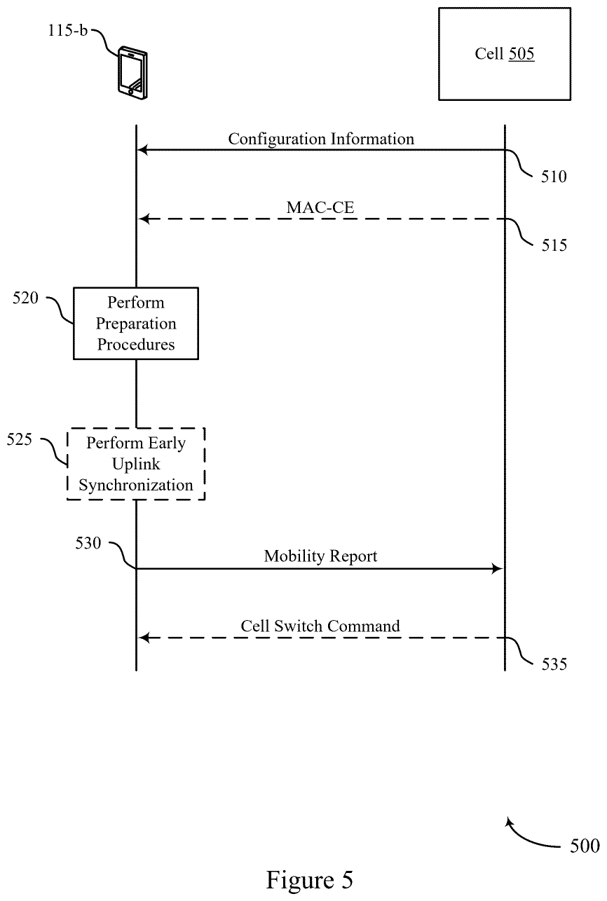

FIG. 5 shows an example of a process flow 500 that supports early CA preparation for handover. Aspects of the process flow 500 may implement or be implemented by aspects of the wireless communication system 100, the signaling diagram 200, or both. For example, the process flow 500 may include a UE 115-b and a cell 505 (e.g., a serving cell of the UE 115-b), which may be examples of the UE 115 and the network entity 105 or the one or more cells 205 respectively.

In the following description of the process flow 500, the operations between the UE 115-b and the cell 505 may be performed in different orders or at different times. Some operations may also be left out of the process flow 500, or other operations may be added. Although the UE 115-b and the cell 505 are shown performing the operations of the process flow 500, some aspects of some operations may also be performed by one or more other wireless devices.

At 510, the cell 505 may output, and the UE 115-b may receive, configuration information associated with a candidate CA configuration including a set of candidate cells, where the set of candidate cells includes at least a PCell and one or more SCells. The configuration may include one or more parameters associated with acquisition, by the UE 115-b, of one or more target SCells of the set of cells. For example, the configuration information may include one or more sub-configurations associated with the set of candidate cells as further described herein with reference to FIG. 2. Additionally, or alternatively, the configuration information may include one or more additional parameters associated with acquisition of the target SCells as further described herein with reference to FIG. 4.

At 515, the cell 505 may output, and the UE 115-b may receive, a MAC-CE message including a TCI activation MAC-CE, which is further described herein with reference to FIG. 2. For example, the cell 505 may indicate, via the MAC-CE, message may indicate one or more active TCI states associated with each PCell, SCell, or both of the one or more candidate cells. In such examples, the MAC-CE message may include an indication of one or more activated (e.g., present) TCI state types (e.g., downlink TCI, uplink TCI, or joint downlink and uplink TCI) associated with each cell of the one or more candidate cells.

At 520, the UE 115-b may perform one or more early preparation procedures associated with acquisition of the one or more target SCells, which are further described herein with reference to FIG. 2. For example, the UE 115-b may perform the early preparation configurations based on receiving the configuration information of 510. In some examples, the UE may perform, as part of the early preparation procedures, early TCI activation based on the indication of the activated TCI states indicated in the MAC-CE message of 515 for each SCell of the target SCells. Additionally, or alternatively, at 525, the UE 115-b may perform early uplink synchronization as part of the early preparation procedures, which is further described herein with reference to FIG. 2.

At 530, the UE 115-b may generate and transmit a mobility report (e.g., a LTM mobility report). In some examples, the UE 115-b may perform beam measurements for one or more beams of one or more candidate cells associated with one or more candidate CA configurations. In some examples, the UE 115-b may generate the mobility report including the beam measurements according to one or more report formats further described herein with reference to FIGS. 3A through 3D. For example, the UE 115-b may generate the mobility report according to one or more of a format based on a respective candidate CA configuration, a respective cell type, a quantity of reported cells, or an overall L1 measurement value (e.g., a RSRP value).

At 535, the cell 505 may output, and the UE 115-b may receive, a cell switch command indicting for the UE 115-b to switch to communicating with one or more cells different than the cell 505. For example, the UE 115-b may switch to communicating with a target SCell based on receiving the cell switch command and based on one or more of performing the early preparation procedures of 520 or the early uplink synchronization of 525. In some examples, the cell switch command may include an indication of one or more additional parameters associated with acquisition of the target SCell as further described herein with reference to FIG. 4.

By performing the early preparation procedures (e.g., early activation procedures) in accordance with at least the configuration information, the UE 115-b may activate the one or more SCells and may switch to communicating with the target SCell at a same time as receiving the cell switch command of 535, which may reduce a latency associated with the cell switch compared to performing SCell activation (e.g., via the SCell activation command) after switching to communicating with the PCell.

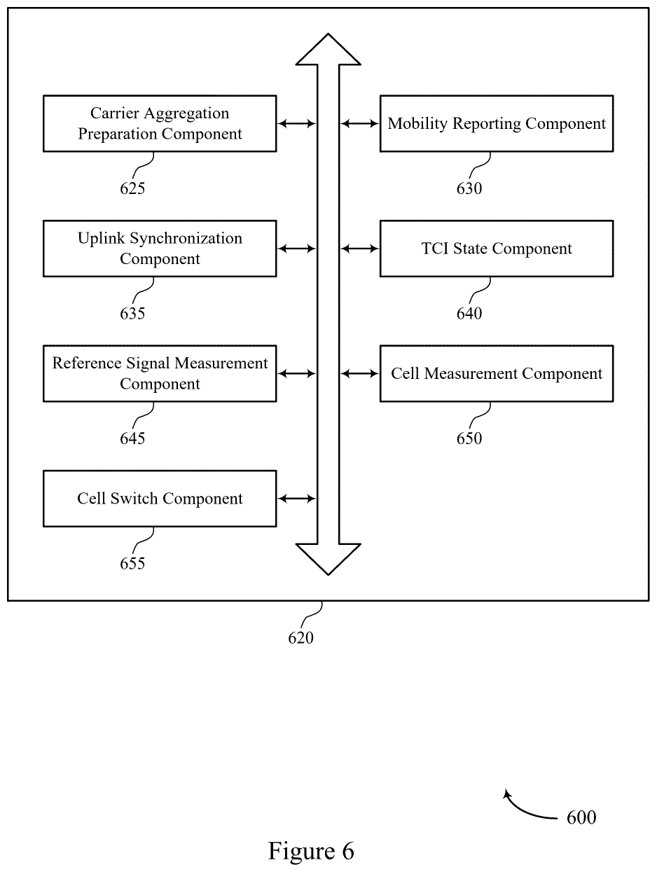

FIG. 6 shows an example of a processing system 620 that supports early CA preparation for handover. A processing system 620 may be an example of a processing system 140 (such as of a UE 115) and may include a carrier aggregation preparation component 625, a mobility reporting component 630, an uplink synchronization component 635, a TCI state component 640, a reference signal measurement component 645, a cell measurement component 650, a cell switch component 655, or any combination thereof. A processing system 620, or various component thereof, may be an example of means for performing (such as a means for causing a UE 115 to perform) various techniques described herein.

The carrier aggregation preparation component 625 may be configured to cause the UE 115 to receive configuration information associated with a set of multiple candidate cells, where the set of multiple candidate cells includes at least a primary cell and one or more secondary cells, and where the configuration information is associated with acquisition, by the UE, of one or more target secondary cell parameters before a reception of a cell switch command or secondary cell activation command, at a same time as the reception of the cell switch command or secondary cell activation command, or both. In some examples, the carrier aggregation preparation component 625 may be configured to cause the UE 115 to perform a secondary cell preparation procedure associated with the one or more secondary cells in accordance with the configuration information. The mobility reporting component 630 may be configured to cause the UE 115 to transmit a mobility report that includes an indication of one or metrics associated with the one or more secondary cells and based on the secondary cell preparation procedure.

In some examples, to support receiving the configuration information, the carrier aggregation preparation component 625 may be configured to cause the UE 115 to receive a set of multiple first configurations that pertain to the acquisition of the one or more target secondary cell parameters, where the set of multiple first configurations are associated with first resources on a per-resource basis, and where the first resources are bands or locations or combinations thereof that differ from second resources associated with the primary cell.

In some examples, the carrier aggregation preparation component 625 may be configured to cause the UE 115 to transmit, as part of the secondary cell preparation procedure, one or more sounding reference signals in accordance with the configuration information, where transmission of the one or more sounding reference signals is for determination of one or more precoders for uplink communications, downlink communications or both, or is associated with one or more beam refinement procedures.

In some examples, the carrier aggregation preparation component 625 may be configured to cause the UE 115 to obtain, as part of the secondary cell preparation procedure, one or more channel state information measurements associated with the one or more secondary cells in accordance with the configuration information. In some examples, the carrier aggregation preparation component 625 may be configured to cause the UE 115 to generate a channel state information report for the one or more secondary cells based on the one or more channel state information measurements, where generation of the channel state information report is for determination of one or more precoders for downlink communications, or is associated with one or more beam refinement procedures.

In some examples, the uplink synchronization component 635 may be configured to cause the UE 115 to receive signaling associated with an uplink synchronization procedure, where the signaling indicates one or more cells of the set of multiple candidate cells including at least the one or more secondary cells for timing synchronization during the uplink synchronization procedure.

In some examples, the uplink synchronization component 635 may be configured to cause the UE 115 to perform the uplink synchronization procedure for the one or more cells of the set of multiple candidate cells in accordance with the signaling and in accordance with an ordering, where the ordering is based on index values for each cell of the set of multiple candidate cells, one or more uplink synchronization configuration identifiers indicated by the signaling and associated with each cell of the set of multiple candidate cells, or both.

In some examples, to support performing the uplink synchronization procedure, the uplink synchronization component 635 may be configured to cause the UE 115 to determine a set of multiple timing advances, with each timing advance corresponding to an individual configuration of a set of multiple first configurations, and where the set of multiple first configurations include the configuration information that pertains to the acquisition of the one or more target secondary cell parameters.

In some examples, the TCI state component 640 may be configured to cause the UE 115 to receive signaling indicating an activation of one or more transmission control indicator states of a set of multiple transmission control indicator states included in the configuration information, where each transmission control indicator state of the set of multiple transmission control indicator states is associated with a respective secondary cell of the one or more secondary cells.

In some examples, the reference signal measurement component 645 may be configured to cause the UE 115 to receive signaling indicating a set of multiple reference signal sets, where each reference signal set of the set of multiple reference signal sets is associated with a respective secondary cell of the one or more secondary cells.

In some examples, each reference signal set of the set of multiple reference signal sets is associated with a respective reference signal identifier value indicated by the signaling and associated with each cell of the set of multiple candidate cells, indicated by the configuration information, or both.

In some examples, the cell measurement component 650 may be configured to cause the UE 115 to obtain, for the one or more secondary cells, the one or more metrics in accordance with the configuration information.

In some examples, the mobility reporting component 630 may be configured to cause the UE 115 to transmit, via the mobility report, an indication of one or more beams per candidate cell of the set of multiple candidate cells and an indication of a respective metric of the one or more metrics for each beam of the one or more beams per candidate cell, where a quantity of candidate cells included in the mobility report satisfies a threshold quantity of candidate cells, and where an order of the one or more beams per candidate cell is in accordance with the respective metric, a cell type, a candidate cell configuration, or any combination thereof.

In some examples, the mobility reporting component 630 may be configured to cause the UE 115 to transmit, via the mobility report, an indication of one or more reserved entries of the mobility report, an indication of one or more additional respective metrics associated with one or more additional cells different from the primary cell and the one or more secondary cells, or both in accordance with the quantity of candidate cells included in the mobility report failing to satisfy the threshold quantity of candidate cells, where a quantity of the one or more reserved entries, a quantity of the one or more additional cells, or both included in the mobility report is in accordance with the threshold quantity of candidate cells.

In some examples, the mobility reporting component 630 may be configured to cause the UE 115 to transmit signaling indicating a report size associated with the mobility report, where the report size is in accordance with the quantity of candidate cells included in the mobility report.

In some examples, the cell switch component 655 may be configured to cause the UE 115 to receive signaling including a cell switch command, the cell switch command including an indication of one or more target cells of the set of multiple candidate cells and a set of multiple additional target cell parameters associated with acquisition, by the UE, of the one or more secondary cells.

In some examples, the cell switch component 655 may be configured to cause the UE 115 to perform a cell switch procedure in accordance with the cell switch command and in accordance with the set of multiple additional target cell parameters, the configuration information, or both, where the cell switch procedure includes switching from communicating with a serving cell to communicating with the one or more target cells.

A processing system 620 may include or be a component of one or more chips, systems-on-chips (SoCs), chipsets, packages, components, or devices that individually or collectively constitute or include a processing system. A processing system 620 may interface with other components of a processing system 620. For example, operations described with reference to a processing system 620, or various components thereof, may be performed by or with other such components, including a receiver, a transmitter, a transceiver, a modem, a user interface, a modulator/demodulator, an encoder/decoder, or any combination thereof (such as of the processing system 620, coupled with the processing system 620, of a processing system 620).

By including or configuring a processing system 620 for operation in a processing system 620 as described herein, the processing system 620 may support techniques for such as reduced processing or more efficient utilization of communication resources, among other benefits.

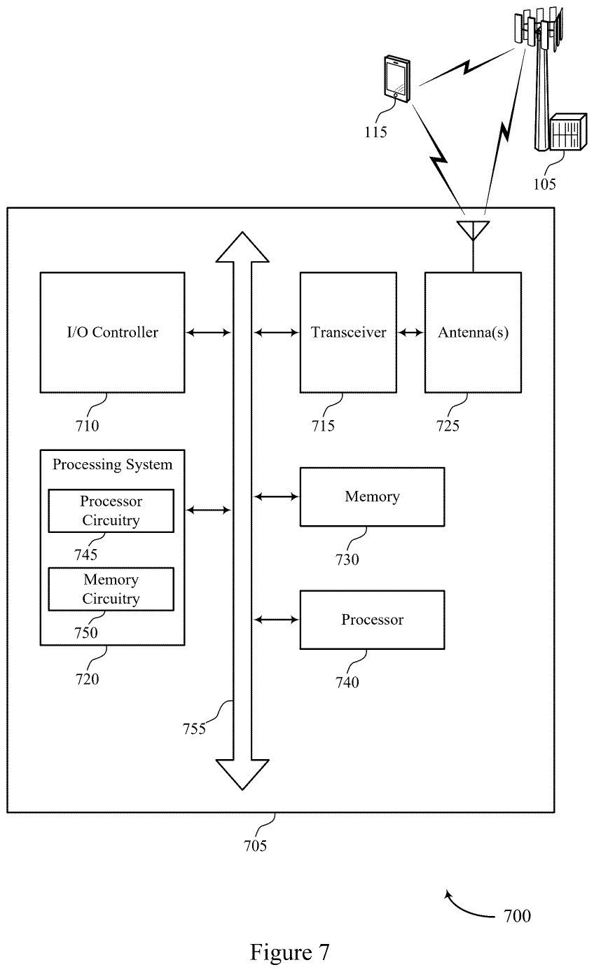

FIG. 7 shows an example of a system 700 including a device 705 that supports early CA preparation for handover. The device 705 may be an example of or include components of UE 115. The device 705 may communicate (such as wirelessly) with one or more other devices (such as network entities 105, UEs 115). The device 705 may include components for transmitting and receiving communication, which may include a processing system 720, an input/output (I/O) controller, such as an I/O controller 710, a transceiver 715, antenna(s) 725, a memory 730, and a processor 740. Components of the device 705 may be coupled (such as operatively, communicatively, functionally, electronically, electrically, in electronic communication) a bus 755.

The transceiver 715 may support bi-directional communication via antenna(s) 725, and may support transmission operations, reception operations, or both, as described herein. The transceiver 715 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 705). The transceiver 715 may modulate symbols and provide the modulated symbols to antenna(s) 725 for transmission, and demodulate symbols from signals received using antenna(s) 725.

The processor 740 may be a general-purpose processing component that supports various operations (such as applications) of the device 705. The memory 730 may be a general-purpose storage component that stores code executable by the processor 740. Such code may include instructions that, when executed by the processor 740, cause the device 705 to perform various functions (such as to support an application of the device 705). The I/O controller 710 may manage inputs and outputs for the device 705, may manage peripherals not integrated into the device 705, or may represent a physical connection (such as port) to an external peripheral. The processor 740 may interact with a modem, a keyboard, a mouse, a touchscreen, or other device (such as via I/O controller 710). In some implementations, a user may interact with the device 705 via the I/O controller 710 or via hardware components controlled by the I/O controller 710.

The processing system 720 may be an example of a processing system 140 or a processing system 600. For example, the processing system 720 may include processor circuitry 745 and memory circuitry 750 that stores code, and may be configured to cause the device 705 to perform operations that support early CA preparation for handover. Although the processing system 720 is illustrated as a separate component, which may involve a separate chip, chipset, or other module, in some implementations, one or more functions described with reference to the processing system 720 may be supported by or performed by a transceiver 715, antenna(s) 725, a processor 740, memory 730, or any combination thereof, such that a processing system 720 may include one or more of a transceiver 715, antenna(s) 725, a processor 740, memory 730, or any combination thereof.

By including or configuring the processing system 720 for operation in the device 705 as described herein, may support techniques for reduced latency, more efficient utilization of communication resources, improved coordination between devices, and improved utilization of processing capability, among other benefits.

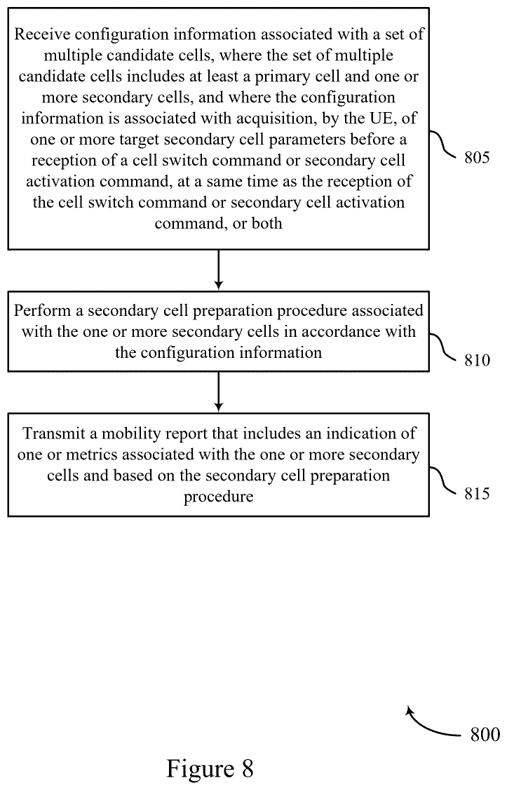

FIG. 8 shows an example of a method 800 that supports early CA preparation for handover. Operations of the method 800 may be performed by a UE or its components (such as using a processing system configured to cause the UE 115 to perform one or more of the operations) as described herein.

At 805, the method may include receiving configuration information associated with a set of multiple candidate cells, where the set of multiple candidate cells includes at least a primary cell and one or more secondary cells, and where the configuration information is associated with acquisition, by the UE, of one or more target secondary cell parameters before a reception of a cell switch command or secondary cell activation command, at a same time as the reception of the cell switch command or secondary cell activation command, or both. In some examples, aspects of the operations of 805 may be performed by a carrier aggregation preparation component 625.

At 810, the method may include performing a secondary cell preparation procedure associated with the one or more secondary cells in accordance with the configuration information. In some examples, aspects of the operations of 810 may be performed by a carrier aggregation preparation component 625.

At 815, the method may include transmitting a mobility report that includes an indication of one or metrics associated with the one or more secondary cells and based on the secondary cell preparation procedure. In some examples, aspects of the operations of 815 may be performed by a mobility reporting component 630.

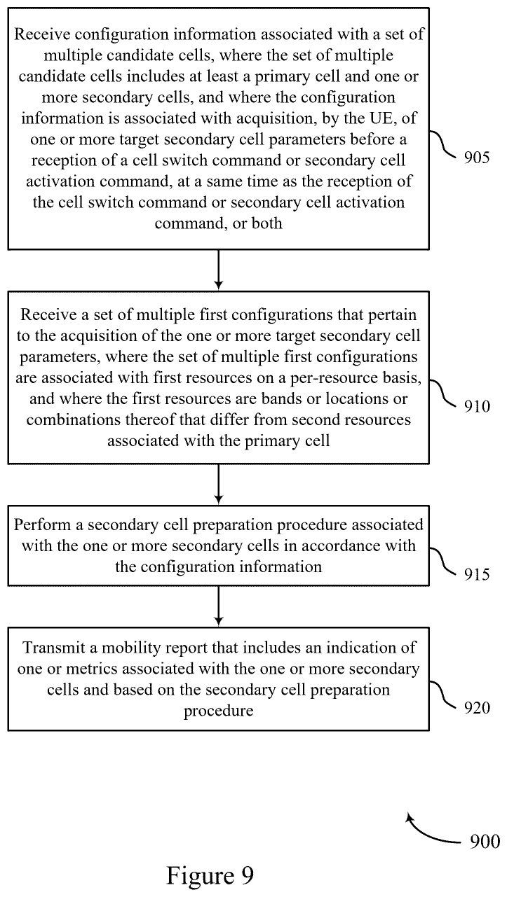

FIG. 9 shows an example of a method 900 that supports early CA preparation for handover. Operations of the method 900 may be performed by a UE or its components (such as using a processing system configured to cause the UE 115 to perform one or more of the operations) as described herein.

At 905, the method may include receiving configuration information associated with a set of multiple candidate cells, where the set of multiple candidate cells includes at least a primary cell and one or more secondary cells, and where the configuration information is associated with acquisition, by the UE, of one or more target secondary cell parameters before a reception of a cell switch command or secondary cell activation command, at a same time as the reception of the cell switch command or secondary cell activation command, or both. In some examples, aspects of the operations of 905 may be performed by a carrier aggregation preparation component 625.

At 910, the method may include receiving a set of multiple first configurations that pertain to the acquisition of the one or more target secondary cell parameters, where the set of multiple first configurations are associated with first resources on a per-resource basis, and where the first resources are bands or locations or combinations thereof that differ from second resources associated with the primary cell. In some examples, aspects of the operations of 910 may be performed by a carrier aggregation preparation component 625.

At 915, the method may include performing a secondary cell preparation procedure associated with the one or more secondary cells in accordance with the configuration information. In some examples, aspects of the operations of 915 may be performed by a carrier aggregation preparation component 625.

At 920, the method may include transmitting a mobility report that includes an indication of one or metrics associated with the one or more secondary cells and based on the secondary cell preparation procedure. In some examples, aspects of the operations of 920 may be performed by a mobility reporting component 630.

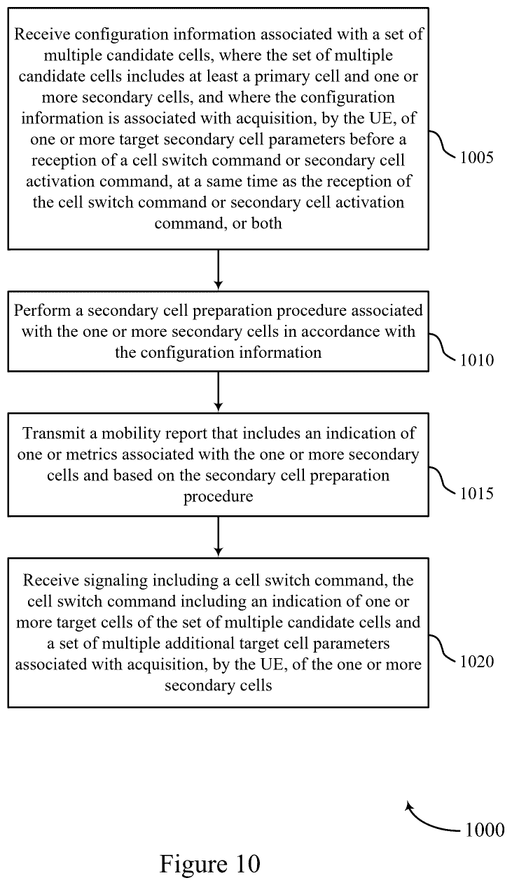

FIG. 10 shows an example of a method 1000 that supports early CA preparation for handover. Operations of the method 1000 may be performed by a UE or its components (such as using a processing system configured to cause the UE 115 to perform one or more of the operations) as described herein.

At 1005, the method may include receiving configuration information associated with a set of multiple candidate cells, where the set of multiple candidate cells includes at least a primary cell and one or more secondary cells, and where the configuration information is associated with acquisition, by the UE, of one or more target secondary cell parameters before a reception of a cell switch command or secondary cell activation command, at a same time as the reception of the cell switch command or secondary cell activation command, or both. In some examples, aspects of the operations of 1005 may be performed by a carrier aggregation preparation component 625.

At 1010, the method may include performing a secondary cell preparation procedure associated with the one or more secondary cells in accordance with the configuration information. In some examples, aspects of the operations of 1010 may be performed by a carrier aggregation preparation component 625.

At 1015, the method may include transmitting a mobility report that includes an indication of one or metrics associated with the one or more secondary cells and based on the secondary cell preparation procedure. In some examples, aspects of the operations of 1015 may be performed by a mobility reporting component 630.

At 1020, the method may include receiving signaling including a cell switch command, the cell switch command including an indication of one or more target cells of the set of multiple candidate cells and a set of multiple additional target cell parameters associated with acquisition, by the UE, of the one or more secondary cells. In some examples, aspects of the operations of 1020 may be performed by a cell switch component 655.

The following provides an overview of aspects of the present disclosure:

Aspect 1: A method for wireless communications at a UE, comprising: receiving configuration information associated with a plurality of candidate cells, wherein the plurality of candidate cells includes at least a primary cell and one or more secondary cells, and wherein the configuration information is associated with acquisition, by the UE, of one or more target secondary cell parameters before a reception of a cell switch command or secondary cell activation command, at a same time as the reception of the cell switch command or secondary cell activation command, or both; performing a secondary cell preparation procedure associated with the one or more secondary cells in accordance with the configuration information; and transmitting a mobility report that includes an indication of one or metrics associated with the one or more secondary cells and based at least in part on the secondary cell preparation procedure.

Aspect 2: The method of aspect 1, wherein receiving the configuration information further comprises: receiving a plurality of first configurations that pertain to the acquisition of the one or more target secondary cell parameters, wherein the plurality of first configurations are associated with first resources on a per-resource basis, and wherein the first resources are bands or locations or combinations thereof that differ from second resources associated with the primary cell.

Aspect 3: The method of any of aspects 1 through 2, further comprising: transmitting, as part of the secondary cell preparation procedure, one or more sounding reference signals in accordance with the configuration information, wherein transmission of the one or more sounding reference signals is for determination of one or more precoders for uplink communications, downlink communications or both, or is associated with one or more beam refinement procedures.

Aspect 4: The method of any of aspects 1 through 3, further comprising: obtaining, as part of the secondary cell preparation procedure, one or more channel state information measurements associated with the one or more secondary cells in accordance with the configuration information; and generating a channel state information report for the one or more secondary cells based on the one or more channel state information measurements, wherein generation of the channel state information report is for determination of one or more precoders for downlink communications, or is associated with one or more beam refinement procedures.

Aspect 5: The method of any of aspects 1 through 4, further comprising: receiving signaling associated with an uplink synchronization procedure, wherein the signaling indicates one or more cells of the plurality of candidate cells including at least the one or more secondary cells for timing synchronization during the uplink synchronization procedure.

Aspect 6: The method of aspect 5, further comprising: performing the uplink synchronization procedure for the one or more cells of the plurality of candidate cells in accordance with the signaling and in accordance with an ordering, wherein the ordering is based on index values for each cell of the plurality of candidate cells, one or more uplink synchronization configuration identifiers indicated by the signaling and associated with each cell of the plurality of candidate cells, or both.

Aspect 7: The method of aspect 6, wherein performing the uplink synchronization procedure further comprises: determining a plurality of timing advances, with each timing advance corresponding to an individual configuration of a plurality of first configurations, and wherein the plurality of first configurations comprise the configuration information that pertains to the acquisition of the one or more target secondary cell parameters.

Aspect 8: The method of any of aspects 1 through 7, further comprising: receiving signaling indicating an activation of one or more transmission control indicator states of a plurality of transmission control indicator states included in the configuration information, wherein each transmission control indicator state of the plurality of transmission control indicator states is associated with a respective secondary cell of the one or more secondary cells.

Aspect 9: The method of any of aspects 1 through 8, further comprising: receiving signaling indicating a plurality of reference signal sets, wherein each reference signal set of the plurality of reference signal sets is associated with a respective secondary cell of the one or more secondary cells.

Aspect 10: The method of aspect 9, wherein each reference signal set of the plurality of reference signal sets is associated with a respective reference signal identifier value indicated by the signaling and associated with each cell of the plurality of candidate cells, indicated by the configuration information, or both.

Aspect 11: The method of any of aspects 1 through 10, further comprising: obtaining, for the one or more secondary cells, the one or more metrics in accordance with the configuration information.

Aspect 12: The method of aspect 11, further comprising: transmitting, via the mobility report, an indication of one or more beams per candidate cell of the plurality of candidate cells and an indication of a respective metric of the one or more metrics for each beam of the one or more beams per candidate cell, wherein a quantity of candidate cells included in the mobility report satisfies a threshold quantity of candidate cells, and wherein an order of the one or more beams per candidate cell is in accordance with the respective metric, a cell type, a candidate cell configuration, or any combination thereof.

Aspect 13: The method of aspect 12, further comprising: transmitting, via the mobility report, an indication of one or more reserved entries of the mobility report, an indication of one or more additional respective metrics associated with one or more additional cells different from the primary cell and the one or more secondary cells, or both in accordance with the quantity of candidate cells included in the mobility report failing to satisfy the threshold quantity of candidate cells, wherein a quantity of the one or more reserved entries, a quantity of the one or more additional cells, or both included in the mobility report is in accordance with the threshold quantity of candidate cells.

Aspect 14: The method of any of aspects 12 through 13, further comprising: transmitting signaling indicating a report size associated with the mobility report, wherein the report size is in accordance with the quantity of candidate cells included in the mobility report.

Aspect 15: The method of any of aspects 1 through 14, further comprising: receiving signaling comprising a cell switch command, the cell switch command including an indication of one or more target cells of the plurality of candidate cells and a plurality of additional target cell parameters associated with acquisition, by the UE, of the one or more secondary cells.

Aspect 16: The method of aspect 15, further comprising: performing a cell switch procedure in accordance with the cell switch command and in accordance with the plurality of additional target cell parameters, the configuration information, or both, wherein the cell switch procedure includes switching from communicating with a serving cell to communicating with the one or more target cells.

Aspect 17: A method for wireless communications at a network entity, comprising: transmitting configuration information associated with a plurality of candidate cells, wherein the plurality of candidate cells includes at least a primary cell and one or more secondary cells, and wherein the configuration information is associated with acquisition, by a UE, of one or more target secondary cell parameters before a reception of a cell switch command or secondary cell activation command, at a same time as the reception of the cell switch command or secondary cell activation command, or both; and receiving a mobility report that includes an indication of one or metrics associated with the one or more secondary cells.

Aspect 18: The method of aspect 17, wherein transmitting the configuration information further comprises: transmitting a plurality of first configurations that pertain to the acquisition of the one or more target secondary cell parameters, wherein the plurality of first configurations are associated with first resources on a per-resource basis, and wherein the first resources are bands or locations or combinations thereof that differ from second resources associated with the primary cell.

Aspect 19: The method of any of aspects 17 through 18, further comprising: receiving one or more sounding reference signals in accordance with the configuration information, wherein communication of the one or more sounding reference signals is for determination of one or more precoders for uplink communications, downlink communications or both, or is associated with one or more beam refinement procedures.

Aspect 20: The method of any of aspects 17 through 19, further comprising: transmitting signaling associated with an uplink synchronization procedure, wherein the signaling indicates one or more cells of the plurality of candidate cells including at least the one or more secondary cells for timing synchronization during the uplink synchronization procedure.

Aspect 21: The method of any of aspects 17 through 20, further comprising: transmitting signaling indicating an activation of one or more transmission control indicator states of a plurality of transmission control indicator states included in the configuration information, wherein each transmission control indicator state of the plurality of transmission control indicator states is associated with a respective secondary cell of the one or more secondary cells.

Aspect 22: The method of any of aspects 17 through 21, further comprising: transmitting signaling indicating a plurality of reference signal sets, wherein each reference signal set of the plurality of reference signal sets is associated with a respective secondary cell of the one or more secondary cells.

Aspect 23: The method of aspect 22, wherein each reference signal set of the plurality of reference signal sets is associated with a respective reference signal identifier value indicated by the signaling and associated with each cell of the plurality of candidate cells, indicated by the configuration information, or both.

Aspect 24: The method of any of aspects 17 through 23, further comprising: receiving, via the mobility report, an indication of one or more beams per candidate cell of the plurality of candidate cells and an indication of a respective metric of the one or more metrics for each beam of the one or more beams per candidate cell, wherein a quantity of candidate cells included in the mobility report satisfies a threshold quantity of candidate cells, and wherein an order of the one or more beams per candidate cell is in accordance with the respective metric, a cell type, a candidate cell configuration, or any combination thereof.

Aspect 25: The method of aspect 24, further comprising: receiving, via the mobility report, an indication of one or more reserved entries of the mobility report, an indication of one or more additional respective metrics associated with one or more additional cells different from the primary cell and the one or more secondary cells, or both in accordance with the quantity of candidate cells included in the mobility report failing to satisfy the threshold quantity of candidate cells, wherein a quantity of the one or more reserved entries, a quantity of the one or more additional cells, or both included in the mobility report is in accordance with the threshold quantity of candidate cells.

Aspect 26: The method of any of aspects 24 through 25, further comprising: receiving signaling indicating a report size associated with the mobility report, wherein the report size is in accordance with the quantity of candidate cells included in the mobility report.

Aspect 27: The method of any of aspects 17 through 26, further comprising: transmitting signaling comprising a cell switch command, the cell switch command including an indication of one or more target cells of the plurality of candidate cells and a plurality of additional target cell parameters associated with acquisition, by the UE, of the one or more secondary cells.

Aspect 28: A UE for wireless communications, comprising a processing system that includes processor circuitry and memory circuitry that stores code, the processing system configured to cause the UE to perform a method of any of aspects 1 through 16.

Aspect 29: A UE for wireless communications, comprising at least one means for performing a method of any of aspects 1 through 16.

Aspect 30: A non-transitory computer-readable medium storing code for wireless communications, the code comprising instructions executable by one or more processors to perform a method of any of aspects 1 through 16.

Aspect 31: A network entity for wireless communications, comprising a processing system that includes processor circuitry and memory circuitry that stores code, the processing system configured to cause the network entity to perform a method of any of aspects 17 through 27.

Aspect 32: A network entity for wireless communications, comprising at least one means for performing a method of any of aspects 17 through 27.

Aspect 33: A non-transitory computer-readable medium storing code for wireless communications, the code comprising instructions executable by one or more processors to perform a method of any of aspects 17 through 27.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components or actions, among other examples. The phrase “associated with” may be interpreted to mean or be interchanged with “in association with,” “in accordance with,” “based on,” “based at least in part on,” “as a function of,” “in response to,” “responsive to,” “using,” “coupled with,” in communication with,” “configured with,” “included with,” or “in cooperation with,” as appropriate in the relevant context unless otherwise explicitly indicated. Additionally, the use of such phrases does not indicate that what follows the phrase is the focal point or primary factor associated with the limitation preceding the phrase.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
a processing system that includes processor circuitry and memory circuitry that stores code, the processing system configured to cause the UE to:
receive configuration information associated with a plurality of candidate cells, wherein the plurality of candidate cells includes at least a primary cell and one or more secondary cells, and wherein the configuration information is associated with acquisition, by the UE, of one or more target secondary cell parameters before a reception of a cell switch command or secondary cell activation command, at a same time as the reception of the cell switch command or secondary cell activation command, or both;
perform a secondary cell preparation procedure associated with the one or more secondary cells in accordance with the configuration information; and
transmit a mobility report that includes an indication of one or metrics associated with the one or more secondary cells and based at least in part on the secondary cell preparation procedure.

2. The UE of claim 1, wherein, to receive the configuration information, the processing system is configured to cause the UE to:
receive a plurality of first configurations that pertain to the acquisition of the one or more target secondary cell parameters, wherein the plurality of first configurations are associated with first resources on a per-resource basis, and wherein the first resources are bands or locations or combinations thereof that differ from second resources associated with the primary cell.

3. The UE of claim 1, wherein the processing system is further configured to cause the UE to:
transmit, as part of the secondary cell preparation procedure, one or more sounding reference signals in accordance with the configuration information, wherein transmission of the one or more sounding reference signals is for determination of one or more precoders for uplink communications, downlink communications or both, or is associated with one or more beam refinement procedures.

4. The UE of claim 1, wherein the processing system is further configured to cause the UE to:
obtain, as part of the secondary cell preparation procedure, one or more channel state information measurements associated with the one or more secondary cells in accordance with the configuration information; and
generate a channel state information report for the one or more secondary cells based on the one or more channel state information measurements, wherein generation of the channel state information report is for determination of one or more precoders for downlink communications, or is associated with one or more beam refinement procedures.

5. The UE of claim 1, wherein the processing system is further configured to cause the UE to:
receive signaling associated with an uplink synchronization procedure, wherein the signaling indicates one or more cells of the plurality of candidate cells including at least the one or more secondary cells for timing synchronization during the uplink synchronization procedure.

6. The UE of claim 5, wherein the processing system is further configured to cause the UE to:
perform the uplink synchronization procedure for the one or more cells of the plurality of candidate cells in accordance with the signaling and in accordance with an ordering, wherein the ordering is based on index values for each cell of the plurality of candidate cells, one or more uplink synchronization configuration identifiers indicated by the signaling and associated with each cell of the plurality of candidate cells, or both.

7. The UE of claim 6, wherein, to perform the uplink synchronization procedure, the processing system is configured to cause the UE to:
determine a plurality of timing advances, with each timing advance corresponding to an individual configuration of a plurality of first configurations, and wherein the plurality of first configurations comprise the configuration information that pertains to the acquisition of the one or more target secondary cell parameters.

8. The UE of claim 1, wherein the processing system is further configured to cause the UE to:
receive signaling indicating an activation of one or more transmission control indicator states of a plurality of transmission control indicator states included in the configuration information, wherein each transmission control indicator state of the plurality of transmission control indicator states is associated with a respective secondary cell of the one or more secondary cells.

9. The UE of claim 1, wherein the processing system is further configured to cause the UE to:
receive signaling indicating a plurality of reference signal sets, wherein each reference signal set of the plurality of reference signal sets is associated with a respective secondary cell of the one or more secondary cells.

10. The UE of claim 9, wherein each reference signal set of the plurality of reference signal sets is associated with a respective reference signal identifier value indicated by the signaling and associated with each cell of the plurality of candidate cells, indicated by the configuration information, or both.

11. The UE of claim 1, wherein the processing system is further configured to cause the UE to:
obtain, for the one or more secondary cells, the one or more metrics in accordance with the configuration information.

12. The UE of claim 11, wherein the processing system is further configured to cause the UE to:
transmit, via the mobility report, an indication of one or more beams per candidate cell of the plurality of candidate cells and an indication of a respective metric of the one or more metrics for each beam of the one or more beams per candidate cell, wherein a quantity of candidate cells included in the mobility report satisfies a threshold quantity of candidate cells, and wherein an order of the one or more beams per candidate cell is in accordance with the respective metric, a cell type, a candidate cell configuration, or any combination thereof.

13. The UE of claim 12, wherein the processing system is further configured to cause the UE to:
transmit, via the mobility report, an indication of one or more reserved entries of the mobility report, an indication of one or more additional respective metrics associated with one or more additional cells different from the primary cell and the one or more secondary cells, or both in accordance with the quantity of candidate cells included in the mobility report failing to satisfy the threshold quantity of candidate cells, wherein a quantity of the one or more reserved entries, a quantity of the one or more additional cells, or both included in the mobility report is in accordance with the threshold quantity of candidate cells.

14. The UE of claim 12, wherein the processing system is further configured to cause the UE to:
transmit signaling indicating a report size associated with the mobility report, wherein the report size is in accordance with the quantity of candidate cells included in the mobility report.

15. The UE of claim 1, wherein the processing system is further configured to cause the UE to:
receive signaling comprising a cell switch command, the cell switch command including an indication of one or more target cells of the plurality of candidate cells and a plurality of additional target cell parameters associated with acquisition, by the UE, of the one or more secondary cells.

16. The UE of claim 15, wherein the processing system is further configured to cause the UE to:
perform a cell switch procedure in accordance with the cell switch command and in accordance with the plurality of additional target cell parameters, the configuration information, or both, wherein the cell switch procedure includes switching from communicating with a serving cell to communicating with the one or more target cells.

17. A method for wireless communications at a user equipment (UE), comprising:
receiving configuration information associated with a plurality of candidate cells, wherein the plurality of candidate cells includes at least a primary cell and one or more secondary cells, and wherein the configuration information is associated with acquisition, by the UE, of one or more target secondary cell parameters before a reception of a cell switch command or secondary cell activation command, at a same time as the reception of the cell switch command or secondary cell activation command, or both;
performing a secondary cell preparation procedure associated with the one or more secondary cells in accordance with the configuration information; and
transmitting a mobility report that includes an indication of one or metrics associated with the one or more secondary cells and based at least in part on the secondary cell preparation procedure.

18. The method of claim 17, wherein receiving the configuration information further comprises:
receiving a plurality of first configurations that pertain to the acquisition of the one or more target secondary cell parameters, wherein the plurality of first configurations are associated with first resources on a per-resource basis, and wherein the first resources are bands or locations or combinations thereof that differ from second resources associated with the primary cell.

19. The method of claim 17, further comprising:
transmitting, as part of the secondary cell preparation procedure, one or more sounding reference signals in accordance with the configuration information, wherein transmission of the one or more sounding reference signals is for determination of one or more precoders for uplink communications, downlink communications or both, or is associated with one or more beam refinement procedures.

20. A non-transitory computer-readable medium storing code for wireless communications, the code comprising instructions executable by one or more processors to:
receive configuration information associated with a plurality of candidate cells, wherein the plurality of candidate cells includes at least a primary cell and one or more secondary cells, and wherein the configuration information is associated with acquisition, by a user equipment (UE), of one or more target secondary cell parameters before a reception of a cell switch command or secondary cell activation command, at a same time as the reception of the cell switch command or secondary cell activation command, or both;
perform a secondary cell preparation procedure associated with the one or more secondary cells in accordance with the configuration information; and
transmit a mobility report that includes an indication of one or metrics associated with the one or more secondary cells and based at least in part on the secondary cell preparation procedure.
